(19) United States
(12) Patent Application Publication
(10) Pub. No.: US 2007/0180270 A1
(43) Pub. Date: Aug. 2, 2007

(54) Encryption/decryption device, communication controller, and electronic instrument

(75) Inventors: Tomonori Kumagai, Sapporo-shi (JP); Nobuyuki Saito, Sapporo-shi (JP); Mitsuhiro Matsuo, Ebetsu-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/345,386

(22) Filed: Feb. 2, 2006

(30) Foreign Application Priority Data
Feb. 4, 2005 (JP) 2005-029226

(51) Int. Cl. G06F 12/14

(52) U.S. Cl. 713/193

(57) ABSTRACT

An encryption/decryption device includes a storage section which stores input data and output data, a first encryption/decryption processing section which performs first encryption and decryption processing, and a second encryption/decryption processing section which performs second encryption and decryption processing. The encryption/decryption device stores decrypted data obtained by causing one of the first and second encryption/decryption processing sections to perform the first or second decryption processing for the input data in the storage section. The encryption/decryption device stores data obtained by causing the other of the first and second encryption/decryption processing sections to perform the first or second encryption processing for the decrypted data in the storage section as the output data. The storage area of the storage section for the decrypted data is configured to be inaccessible from the outside of the encryption/decryption device.

Japanese Patent Application No. 2005-29226, filed on Feb. 4, 2005, is hereby incorporated by reference in its entirety.

### BACKGROUND OF THE INVENTION

The present invention relates to an encryption/decryption device, a communication controller, and an electronic instrument.

In recent years, digital broadcasting such as BS digital broadcasting which transmits an MPEG (Moving Picture Experts Group; concretely speaking MPEG2) stream has attracted attention, and electronic instruments such as a digital broadcast tuner and a digital broadcast recorder/player have been widely used. Therefore, content copy prevention technology has been introduced in order to prevent unauthorized digital copying of content.

A digital broadcast tuner and a digital broadcast recorder/player are connected through a general-purpose high-speed serial interface represented by the Institute of Electrical and Electronics Engineers (IEEE) 1394, for example. As copy prevention technology for IEEE1394, the Digital Transmission Content Protect (DTCP) standard has been provided. At present, the DTCP standard is utilized as AV network copy prevention technology along with the spread of the Internet (e.g. DTCP over IP).

JP-A-2001-86481 and JP-A-2003-319322 disclose devices which protect content in such an AV network, for example. JP-A-2001-86481 discloses a device including encryption means, in which an input packet requiring copyright protection and containing an encrypted payload is directly output to a PCI bus outside the device, and a packet which does not require copyright protection is output to the PCI bus after encrypting the payload. JP-A-2003-319322 discloses a device which divides an input packet into a header and a payload, encrypts the payload, combines the header and the encrypted payload, and records the resulting packet in a recording medium outside the device.

In the DTCP standard utilized as the AV network copy prevention technology, it is necessary to employ the US next-generation encryption algorithm called the Advanced Encryption Standard (AES) which replaces the Data Encryption Standard (DES). It is difficult to decipher content encrypted according to AES in comparison with DES.

However, the load of encryption and decryption processing according to the AES encryption algorithm is heavier than the load of encryption and decryption processing according to the DES encryption algorithm. Therefore, when implementing the AES encryption and decryption processing by software, throughput is decreased. Therefore, it is desirable to implement the AES encryption and decryption processing by hardware in order to increase throughput.

On the other hand, if data obtained by decrypting a packet is output to the outside of the device, the content may be digitally and illegally copied. Therefore, it is necessary to output encrypted data to the outside of the device.

### SUMMARY

According to a first aspect of the invention, there is provided an encryption/decryption device to which input data after first encryption processing is input and which outputs output data after second encryption processing, or to which input data after the second encryption processing is input and which outputs output data after the first encryption processing, the encryption/decryption device comprising:

a storage section which stores the input data and the output data;

a first encryption/decryption processing section which performs the first encryption processing and first decryption processing; and

a second encryption/decryption processing section which performs the second encryption processing and second decryption processing,

wherein one of the first and second encryption/decryption processing sections performs the first or second decryption processing for the input data read from the storage section, and the decrypted data is stored in the storage section;

wherein the other of the first and second encryption/decryption processing sections performs the first or second encryption processing for the decrypted data read from the storage section after the first or second decryption processing, and the encrypted data is stored in the storage section as the output data; and

wherein a storage area for the decrypted data in the storage section is inaccessible from outside of the encryption/decryption device.

According to a second aspect of the invention, there is provided an encryption/decryption device to which input data after first encryption processing is input and which outputs output data after second encryption processing, or to which input data after the second encryption processing is input and which outputs output data after the first encryption processing, the encryption/decryption device comprising:

a first storage section which is accessible from outside of the encryption/decryption device and stores the input data;

a first encryption/decryption processing section which performs the first encryption processing and first decryption processing;

a second encryption/decryption processing section which performs the second encryption processing and second decryption processing;

a second storage section which is inaccessible from outside of the encryption/decryption device and stores decrypted data obtained by subjecting the input data to the first or second decryption processing; and

a third storage section which is accessible from outside of the encryption/decryption device and stores the output data,

wherein one of the first and second encryption/decryption processing sections performs the first or second decryption processing for the input data, and the decrypted data is stored in the second storage section; and

wherein the other of the first and second encryption/decryption processing sections performs the first or second encryption processing for the decrypted data after the first or second decryption processing, and the encrypted data is stored in the third storage section as the output data.

According to a third aspect of the invention, there is provided a communication controller used to transmit and receive communication data having a layered structure through a network, the communication controller comprising:

a communication processing section which performs transmission processing and reception processing of the communication data; and

any of the above-described encryption/decryption devices,

wherein, when the communication data is received, the communication processing section analyzes header information, and the encryption/decryption device performs the first decryption processing and then the second encryption processing for data in a layer higher than a layer of the header information as the input data, and then outputs the data as the output data, the first encryption processing having been performed for the data before reception; and

wherein, when the communication data is to be transmitted, the encryption/decryption device performs the second decryption processing and then the first encryption processing for data to be transmitted as the input data, and then outputs the data as the output data, the communication processing section adds higher-layer header information to the output data, and then the communication controller transmits the resulting output data to the network.

According to a fourth aspect of the invention, there is provided an electronic instrument comprising:

the above-described communication controller; and

a processing section which performs the second encryption processing and the second decryption processing,

wherein, when the communication data is received, the communication controller supplies data after the second encryption processing to the processing section; and

wherein, when the communication data is to be transmitted, the processing section supplies data after the second encryption processing to the communication controller as the input data.

### BRIEF DESCRIPTION OF THE SEVERAL VIEWS OF THE DRAWING

FIG. 1 is a diagram showing a configuration example of a communication system including an encryption/decryption device according to one embodiment of the invention.

FIG. 2 is a diagram showing an example of processing compliant with the DTCP standard performed between electronic instruments shown in FIG. 1.

FIG. 3 is a diagram showing a configuration example of various packets used in the communication system shown in FIG. 1.

FIG. 4 is a diagram showing a sequence of an example of content data reception processing in the communication system shown in FIG. 1.

FIG. 5 is a diagram showing a sequence of an example of content data transmission processing in the communication system shown in FIG. 1.

FIG. 6 is a diagram showing another configuration example of various packets used in the communication system shown in FIG. 1.

FIG. 7 is a block diagram showing a configuration example of the encryption/decryption device shown in FIG. 1.

FIGS. 8A and 8B are diagrams showing the flow of processing of an AES processing section.

FIG. 9 is a diagram showing the flow of processing of a DES processing section.

FIG. 10 is a diagram showing a configuration example of a storage section shown in FIG. 7, in which each storage area is set to be variable.

FIG. 11 is a diagram showing a configuration example of a COM header according to one embodiment of the invention.

FIG. 12 is a diagram showing another configuration example of a communication system to which an electronic instrument including the encryption/decryption device according to one embodiment of the invention is applied.

FIG. 13 is a diagram illustrative of an ID field shown in FIG. 11.

FIG. 14 is a diagram illustrative of a TranTYPE field shown in FIG. 11.

FIGS. 15A to 15D are diagrams illustrative of an operation mode corresponding to information set in the TranTYPE field.

FIGS. 16A to 16C are diagrams illustrative of an operation mode corresponding to information set in the TranTYPE field.

FIG. 17 is a diagram illustrative of an operation mode corresponding to information set in the TranTYPE field.

FIG. 18 is a diagram showing a sequence in a program decryption mode.

FIG. 19 is a diagram illustrative of a PCPExtend header and a PCP header.

FIG. 20 is a block diagram showing a hardware configuration example of the encryption/decryption device shown in FIG. 7.

FIG. 21 is a diagram illustrative of the operation of MainSeq shown in FIG. 20.

FIG. 22 is a block diagram showing a configuration example of an encryption/decryption device in a modification of one embodiment of the invention.

### DETAILED DESCRIPTION OF THE EMBODIMENT

The invention may provide an encryption/decryption device, a communication controller, and an electronic instrument which increase throughput by dividing the load of encryption and decryption processing.

The invention may also provide an encryption/decryption device, a communication controller, and an electronic instrument which implement content encryption and decryption processing at high speed while preventing unauthorized copying of content.

According to one embodiment of the invention, there is provided an encryption/decryption device to which input data after first encryption processing is input and which outputs output data after second encryption processing, or to which input data after the second encryption processing is input and which outputs output data after the first encryption processing, the encryption/decryption device comprising:

a storage section which stores the input data and the output data;

a first encryption/decryption processing section which performs the first encryption processing and first decryption processing; and

a second encryption/decryption processing section which performs the second encryption processing and second decryption processing,

wherein one of the first and second encryption/decryption processing sections performs the first or second decryption processing for the input data read from the storage section, and the decrypted data is stored in the storage section;

wherein the other of the first and second encryption/decryption processing sections performs the first or second encryption processing for the decrypted data read from the storage section after the first or second decryption processing, and the encrypted data is stored in the storage section as the output data; and

wherein a storage area for the decrypted data in the storage section is inaccessible from outside of the encryption/decryption device.

In this embodiment, data after the first or second encryption processing is input to and output from the encryption/decryption device. The decrypted data obtained by subjecting the input data to the first or second decryption processing is buffered in the storage area inaccessible from the outside of the encryption/decryption device. Therefore, according to one embodiment of the invention, the processing load imposed on a processing section which sets the input data in the encryption/decryption device can be reduced by the first and second encryption/decryption processing sections, and encrypted data can be transferred between the encryption/decryption device and the processing section. Therefore, since throughput of the processing section can be increased while preventing unauthorized digital copying of data, an encryption/decryption device which can realize encryption and decryption processing of content at high speed can be provided.

According to one embodiment of the invention, there is provided an encryption/decryption device to which input data after first encryption processing is input and which outputs output data after second encryption processing, or to which input data after the second encryption processing is input and which outputs output data after the first encryption processing, the encryption/decryption device comprising:

a first storage section which is accessible from outside of the encryption/decryption device and stores the input data;

a first encryption/decryption processing section which performs the first encryption processing and first decryption processing;

a second encryption/decryption processing section which performs the second encryption processing and second decryption processing;

a second storage section which is inaccessible from outside of the encryption/decryption device and stores decrypted data obtained by subjecting the input data to the first or second decryption processing; and

a third storage section which is accessible from outside of the encryption/decryption device and stores the output data,

wherein one of the first and second encryption/decryption processing sections performs the first or second decryption processing for the input data, and the decrypted data is stored in the second storage section; and

wherein the other of the first and second encryption/decryption processing sections performs the first or second encryption processing for the decrypted data after the first or second decryption processing, and the encrypted data is stored in the third storage section as the output data.

In this embodiment, data after the first or second encryption processing is input to and output from the encryption/decryption device. The decrypted data obtained by subjecting the input data to the first or second decryption processing is buffered in the second storage section inaccessible from the outside of the encryption/decryption device. Therefore, according to one embodiment of the invention, the processing load imposed on a processing section which sets the input data in the encryption/decryption device can be reduced by the first and second encryption/decryption processing sections, and encrypted data can be transferred between the encryption/decryption device and the processing section. Therefore, since throughput of the processing section can be increased while preventing unauthorized digital copying of data, an encryption/decryption device which can realize encryption and decryption processing of content at high speed can be provided.

In this encryption/decryption device,

the first to third storage sections may be respectively provided in divided storage areas in one memory space; and

each of the storage areas may be variable.

In this embodiment, since the storage area of each storage section can be set corresponding to the processing unit of the first encryption and decryption processing and the second encryption and decryption processing, the storage area of the storage section can be effectively utilized.

The encryption/decryption device may comprise:

a header analysis section which analyzes header information added to the input data,

wherein the encryption/decryption device performs at least one of decryption processing for the input data and encryption processing for the decrypted data, the decryption processing being one of the first and second decryption processing and corresponding to the header information, and the encryption processing being one of the first and second encryption processing and corresponding to the header information.

In this embodiment, since the encryption and decryption processing can be controlled based on the header information added to the input data, the configuration and control of the encryption/decryption device can be simplified.

In this encryption/decryption device,

when a first operation mode is designated based on the header information, the first encryption/decryption processing section may generate the decrypted data by performing the first decryption processing for the input data, and the second encryption/decryption processing section may generate the output data by performing the second encryption processing for the decrypted data.

In this embodiment, since data after the first encryption processing can be input as the input data and data after the second encryption processing can be output as the output data, an encryption/decryption device can be provided which can realize an encryption bridge function from the first encryption processing to the second encryption processing at high speed.

In this encryption/decryption device,

when a second operation mode is designated based on the header information, the second encryption/decryption processing section may generate the decrypted data by performing the second decryption processing for the input data, and the first encryption/decryption processing section may generate the output data by performing the first encryption processing for the decrypted data.

In this embodiment, since data after the second encryption processing can be input as the input data and data after the first encryption processing can be output as the output data, an encryption/decryption device can be provided which can realize an encryption bridge function from the second encryption processing to the first encryption processing at high speed.

In this encryption/decryption device,

when a third operation mode is designated based on the header information, the second encryption/decryption processing section may generate the output data by performing the second decryption processing for the input data.

In this embodiment, since data before the second decryption processing can be input as the input data and data after the second encryption processing can be output as the output data, an encryption/decryption device which can realize the function of a decoder which performs the second decryption processing at high speed can be provided.

In this encryption/decryption device,

when a fourth operation mode is designated based on the header information, the first encryption/decryption processing section may generate the output data by performing the first encryption processing for the input data.

In this embodiment, since data before the first encryption processing can be input as the input data and data after the first encryption processing can be output as the output data, an encryption/decryption device which can realize the function of an encoder which performs the first encryption processing at high speed can be provided.

In this encryption/decryption device,

when a fifth operation mode is designated based on the header information, the second encryption/decryption processing section may generate the output data by performing the second encryption processing for the input data.

In this embodiment, since data before the second encryption processing can be input as the input data and data after the second encryption processing can be output as the output data, an encryption/decryption device which can realize the function of an encoder which performs the second encryption processing at high speed can be provided.

In this encryption/decryption device,

when a sixth operation mode is designated based on the header information, the first encryption/decryption processing section may generate the output data by performing the first decryption processing for the input data.

In this embodiment, since data before the first decryption processing can be input as the input data and data after the first decryption processing can be output as the output data, an encryption/decryption device which can realize the function of a decoder which performs the first decryption processing at high speed can be provided.

The encryption/decryption device may comprise:

a controller which controls operation of the encryption/decryption device; and

a program memory which stores a program for designating operation of the controller, the program including data which is used to generate an encryption key for the first and second encryption processing and a decryption key for the first and second decryption processing,

wherein, after the decrypted data has been transferred to the program memory as program data, the controller controls the operation of the encryption/decryption device based on the program data.

In this embodiment, since encrypted program data can be transferred to the program memory, an encryption/decryption device which can be controlled without impairing security can be provided.

In this encryption/decryption device,

the first encryption/decryption processing section may perform encryption and decryption processing compliant with the Advanced Encryption Standard (AES); and

the second encryption/decryption processing section may perform encryption and decryption processing compliant with the Data Encryption Standard (DES).

According to one embodiment of the invention, there is provided a communication controller used to transmit and receive communication data having a layered structure through a network, the communication controller comprising:

a communication processing section which performs transmission processing and reception processing of the communication data; and

any of the above-described encryption/decryption devices,

wherein, when the communication data is received, the communication processing section analyzes header information, and the encryption/decryption device performs the first decryption processing and then the second encryption processing for data in a layer higher than a layer of the header information as the input data, and then outputs the data as the output data, the first encryption processing having been performed for the data before reception; and

wherein, when the communication data is to be transmitted, the encryption/decryption device performs the second decryption processing and then the first encryption processing for data to be transmitted as the input data, and then outputs the data as the output data, the communication processing section adds higher-layer header information to the output data, and then the communication controller transmits the resulting output data to the network.

In this embodiment, a communication controller including an encryption/decryption device which realizes encryption and decryption processing of content at high speed while preventing unauthorized copying can be provided.

According to one embodiment of the invention, there is provided an electronic instrument comprising:

the above-described communication controller; and

a processing section which performs the second encryption processing and the second decryption processing,

wherein, when the communication data is received, the communication controller supplies data after the second encryption processing to the processing section; and

wherein, when the communication data is to be transmitted, the processing section supplies data after the second encryption processing to the communication controller as the input data.

In this embodiment, an electronic instrument including a communication controller which realizes encryption and decryption processing of content at high speed while preventing unauthorized copying can be provided.

These embodiments of the invention will be described in detail below, with reference to the drawings. Note that the embodiments described below do not in any way limit the scope of the invention laid out in the claims herein. In addition, not all of the elements of the embodiments described below should be taken as essential requirements of the invention.

1. Communication System

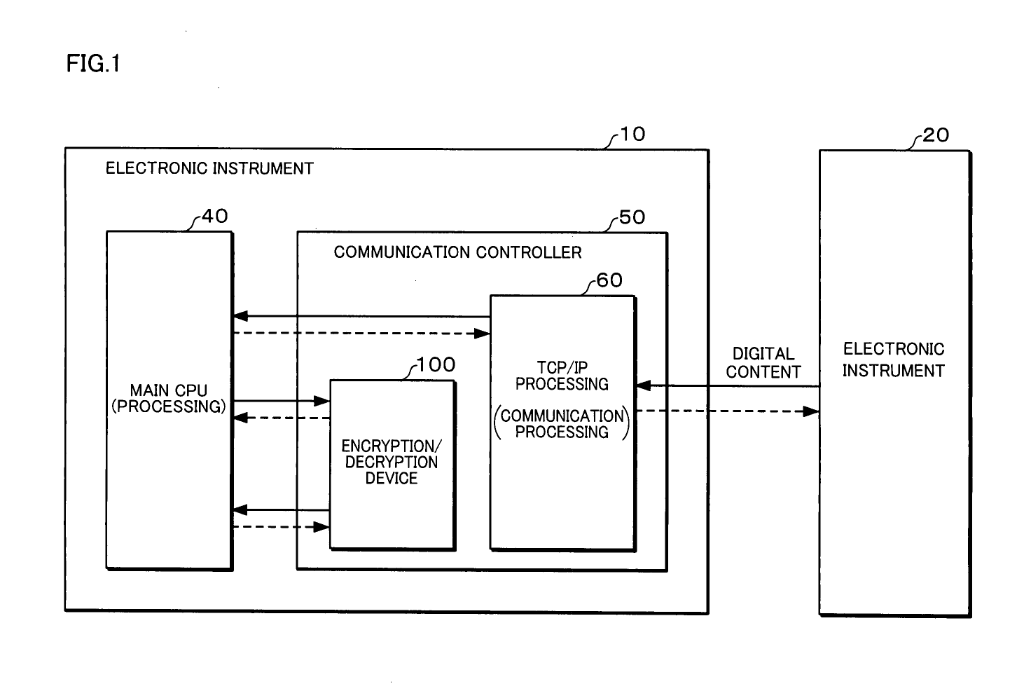

FIG. 1 shows a configuration example of a communication system including an encryption/decryption device according to one embodiment of the invention.

The communication system includes electronic instruments 10 and 20 which transmit and receive communication data including digital content. The electronic instruments 10 and 20 are connected through a network. In order to prevent unauthorized copying, intercepting, and tampering of content data, content data encrypted according to an algorithm compliant with the DTCP standard is transmitted and received between the electronic instruments 10 and 20.

In FIG. 1, the electronic instruments 10 and 20 are connected through an Ethernet® cable, and transmit and receive communication data having a layered structure. However, the electronic instruments 10 and 20 may transmit and receive communication data having a layered structure through a wireless network. The configuration of the electronic instrument 20 may be the same as the configuration of the electronic instrument 10. FIG. 1 shows only the major portion of the configuration of the electronic instrument 10.

The electronic instrument 10 includes a main central processing unit (CPU) (processing section in a broad sense) 40 and a communication controller (network controller) 50. The main CPU 40 controls the entire electronic instrument 10. The communication controller 50 transmits and receives communication data transmitted and received through the Ethernet cable.

The communication controller 50 includes a Transmission Control Protocol/Internet Protocol (TCP/IP) processing section (communication processing section in a broad sense) 60 which operates as a higher-layer analysis section, and an encryption/decryption device (encryption and decryption device or encryption-decryption device) 100.

The TCP/IP processing section 60 generates and analyzes a TCP/IP header added to content data transferred through an Ethernet cable.

The encryption/decryption device 100 performs encryption and decryption processing according to the AES algorithm specified in the DTCP standard to reduce the processing load of the main CPU 40. In order to transfer encrypted content data between the encryption/decryption device 100 and the main CPU 40, the encryption/decryption device 100 also performs encryption and decryption processing according to an algorithm predetermined between the encryption/decryption device 100 and the main CPU 40 in addition to the AES encryption and decryption processing. The encryption/decryption device 100 according to one embodiment of the invention performs encryption and decryption processing according to the DES algorithm when transferring data between the encryption/decryption device 100 and the main CPU 40.

1.1 DTCP

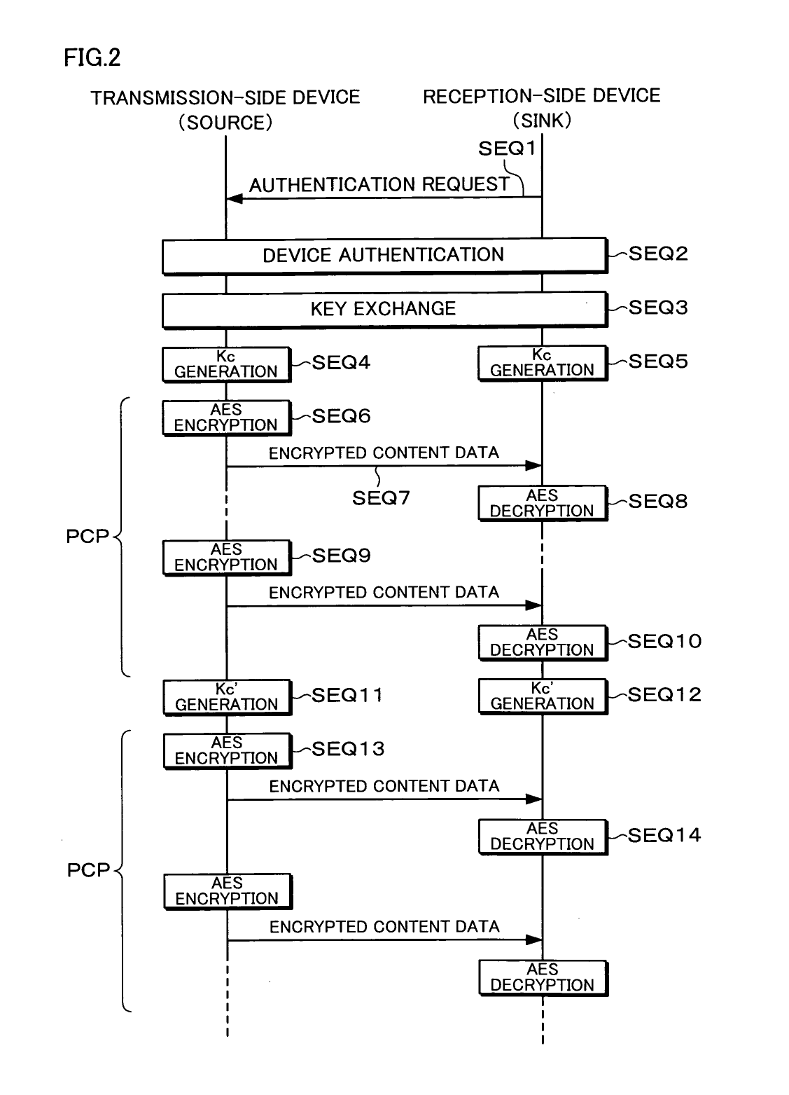

FIG. 2 shows an example of processing compliant with the DTCP standard performed between the electronic instruments 10 and 20 shown in FIG. 1.

In the DTCP standard, authentication processing is performed between a content data transmission-side device called a source and a content data reception-side device called a sink, and the authenticated devices share a content key Kc.

Specifically, the reception-side device requests authentication from the transmission-side device in order to decrypt encrypted content data (SEQ1).

The allows device authentication to be performed between the source and the sink (SEQ2). The device authentication is divided into Full Authentication using public key cryptography and Restricted Authentication using common key cryptography, and is selectively used depending on copy control information of content data, characteristics of the device, and the like. For example, in the DTCP over IP standard used to protect content data transferred through an Ethernet cable, only Full Authentication is permitted.

When each device has authenticated the partner device as a result of device authentication, keys are exchanged (SEQ3). As a result, a random number Nc and an exchange key Kx are shared between the devices. Each device independently generates a content key Kc by using a function shown by the following expression (SEQ4 and SEQ5).
Kc=Func(Kx,C,Nc) (1)

Each device calculates the content key Kc by using the predetermined function Func( ) and the constant C.

The transmission-side device encrypts content data according to the AES algorithm by using the content key Kc, and transmits the encrypted content data to the reception-side device (SEQ6 and SEQ7). The reception-side device decrypts the received content data by using the content key Kc to acquire the content data.

The authenticated devices then transmit and receive content data in the same manner as described above by encrypting and decrypting content data using the content key Kc.

The content data is transmitted and received between the transmission-side device and the reception-side device in units of protected content packets (PCP), and the key is updated in PCP units.

Therefore, when encryption and decryption processing have been performed by using the content key Kc (SEQ9 and SEQ10), the transmission-side device updates the content key Kc upon completion of encryption processing of content data in PCP units. The reception-side device updates the content key Kc upon completion of decryption processing of content data in PCP units. The transmission-side device and the reception-side device generate updated content keys Kc′ by using a function shown by the following expression (SEQ11 and SEQ12).
Kc′=Func(Kx,C,Nc+1) (2)

Then, the transmission-side device encrypts content data according to the AES algorithm by using the content key Kc′, and transmits the encrypted content data to the reception-side device (SEQ13). The reception-side device decrypts the received content data by using the content key Kc′ to acquire the content data (SEQ14).

The authenticated devices then transmit and receive content data in the same manner as described above by encrypting and decrypting content data in PCP units using the content key Kc′.

The details of the DTCP standard are described in “Digital Transmission Content Protection Specification Volume 1 (Informational Version) (Revision 1.3, Jan. 7, 2004)” and “DTCP Volume 1 Supplement E Mapping DTCP to IP (Informational Version) (Revision 1.0, Nov. 24, 2003)”.

In one embodiment of the invention, the authentication processing may be performed by the main CPU 40, and AES encryption and decryption processing (including content key generation) may be performed by the encryption/decryption device 100. An accelerator may be provided inside or outside of the encryption/decryption device 100, and the accelerator may perform the authentication processing.

1.2 Outline of Operation

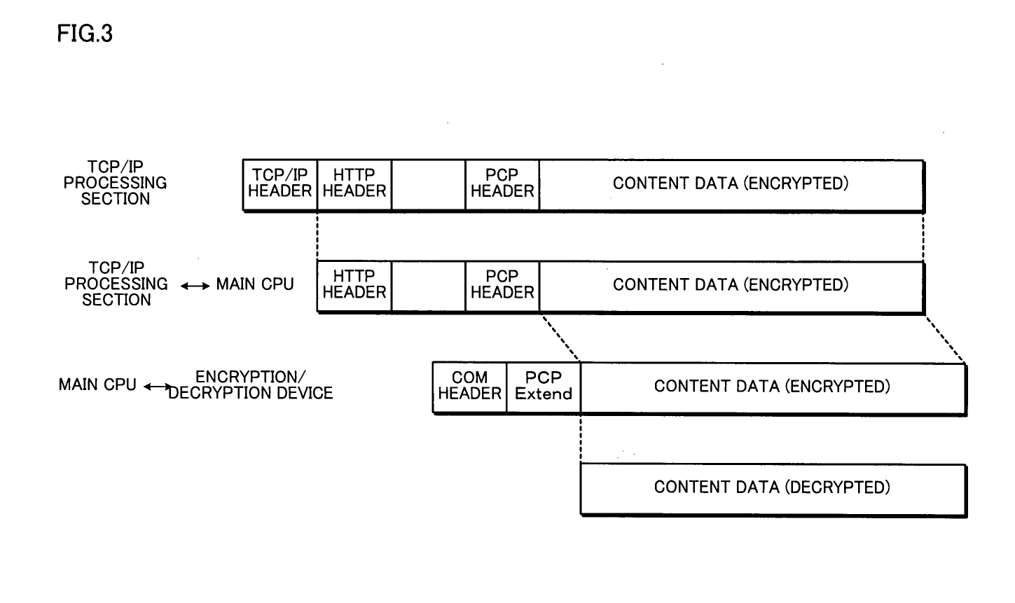

FIG. 3 shows a configuration example of various packets used in the communication system shown in FIG. 1.

A packet received by the electronic instrument 10 as the reception-side device through an Ethernet cable is data in which a PCP header, a Hypertext Transfer Protocol (HTTP) header, and a TCP/IP header are added to content data encrypted according to AES. The TCP/IP processing section 60 analyzes the destination of the TCP/IP header or generates and adds the TCP/IP header.

The data in a layer higher than the layer to which the TCP/IP header is added is transferred between the main CPU 40 and the TCP/IP processing section 60. The main CPU 40 analyzes the HTTP header or generates and adds the HTTP header. The main CPU 40 generates a COM header for controlling the encryption/decryption device 100. The main CPU 40 generates a PCPExtend header by extending the PCP header, and supplies packet data, in which the PCPExtend header and the COM header are added to the encrypted content data, to the encryption/decryption device 100. The PCPExtend header includes information of the PCP header.

The encryption/decryption device 100 performs encryption and decryption processing in order to receive encrypted content data from the main CPU 40. In more detail, when the encryption/decryption device 100 transmits and receives content data which is transmitted and received to and from the TCP/IP processing section 60 through the main CPU 40, the encryption/decryption device 100 transmits and receives content data encrypted according to the AES algorithm specified in the DTCP standard to and from the main CPU 40. When the encryption/decryption device 100 transmits and receives content data transmitted and received to and from the main CPU 40 without being supplied to the TCP/IP processing section 60, the encryption/decryption device 100 transmits and receives content data encrypted according to an algorithm predetermined between the encryption/decryption device 100 and the main CPU 40. In one embodiment of the invention, the DES algorithm is used between the encryption/decryption device 100 and the main CPU 40.

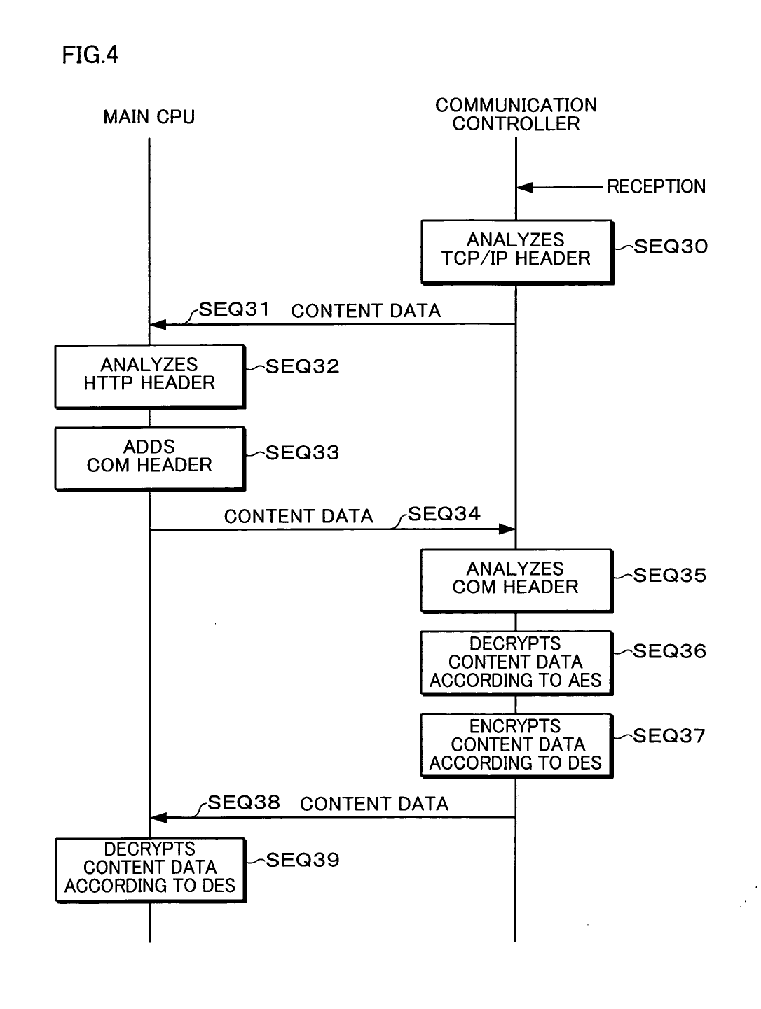

FIG. 4 shows a sequence of an example of content data reception processing in the communication system shown in FIG. 1.

The communication controller 50 receives a packet including content data encrypted according to the AES algorithm. The TCP/IP processing section 60 analyzes the sender and the recipient of the TCP/IP header of the packet and the like (SEQ30). When the TCP/IP processing section 60 has determined that the recipient of the packet is the TCP/IP processing section 60, the TCP/IP processing section 60 supplies the data in a layer higher than the layer to which the TCP/IP header is added and information for identifying the sender and the recipient to the main CPU 40 (SEQ31).

The main CPU 40 analyzes the HTTP header as required (SEQ32), and determines the supplier of the content data based on the information transferred from the TCP/IP processing section 60. The main CPU 40 generates a COM header including identification information ID corresponding to the supplier, and generates a PCPExtend header including the PCP header. The main CPU 40 adds the PCPExtend header and the COM header to the content data (SEQ33), and transmits the content data to the encryption/decryption device 100 of the communication controller 50 (SEQ34).

The encryption/decryption device 100 analyzes the COM header (SEQ35). The encryption/decryption device 100 decrypts the content data according to the AES algorithm based on the analysis result (SEQ36), and encrypts the decrypted content data according to the DES algorithm (SEQ37). A key corresponding to the identification information ID of the COM header is used in the AES decryption processing. The content data encrypted according to the DES algorithm is transmitted to the main CPU 40 (SEQ38).

The main CPU 40 receives the content data encrypted according to the DES algorithm, and decrypts the content data according to the DES algorithm (SEQ39).

As described above, content data encrypted according to the AES or DES algorithm is transferred between the main CPU 40 and the communication controller 50 during the reception processing. Therefore, content data transmitted from the electronic instrument 20 can be acquired while preventing unauthorized copying of content data.

The encryption/decryption device 100 performs decryption processing according to the AES algorithm, which imposes a heavy load, in place of the main CPU 40. The main CPU 40 and the encryption/decryption device 100 transmit and receive encrypted content data. However, since it suffices that the main CPU 40 perform decryption processing according to the DES algorithm, which imposes a low processing load in comparison with the AES algorithm, the processing performance of the main CPU 40 can be used for other processing, so that throughput can be improved.

Moreover, since the encryption/decryption device 100 can generate or update the key according to the DTCP standard or the like, it suffices that the main CPU 40 manage the key between the main CPU 40 and the encryption/decryption device 100.

The TCP/IP processing section 60 of the communication controller 50 analyzes the TCP/IP header and transfers the content data to the main CPU 40. The main CPU 40 then transfers the layer higher than the TCP/IP header to the encryption/decryption device 100 of the communication controller 50. Therefore, even if a middle layer is provided in the future between the layer to which the HTTP header is added and the layer to which the PCP header is added, it is possible to flexibly deal with such a situation without changing the hardware configuration. This is because the analysis function of such a middle layer can be easily added to the function of the main CPU 40 implemented by software.

In the configuration example shown in FIG. 1, the TCP/IP processing section 60 and the encryption/decryption device 100 are included in the communication controller 50. However, the TCP/IP processing section 60 and the encryption/decryption device 100 may be configured as independent functional sections.

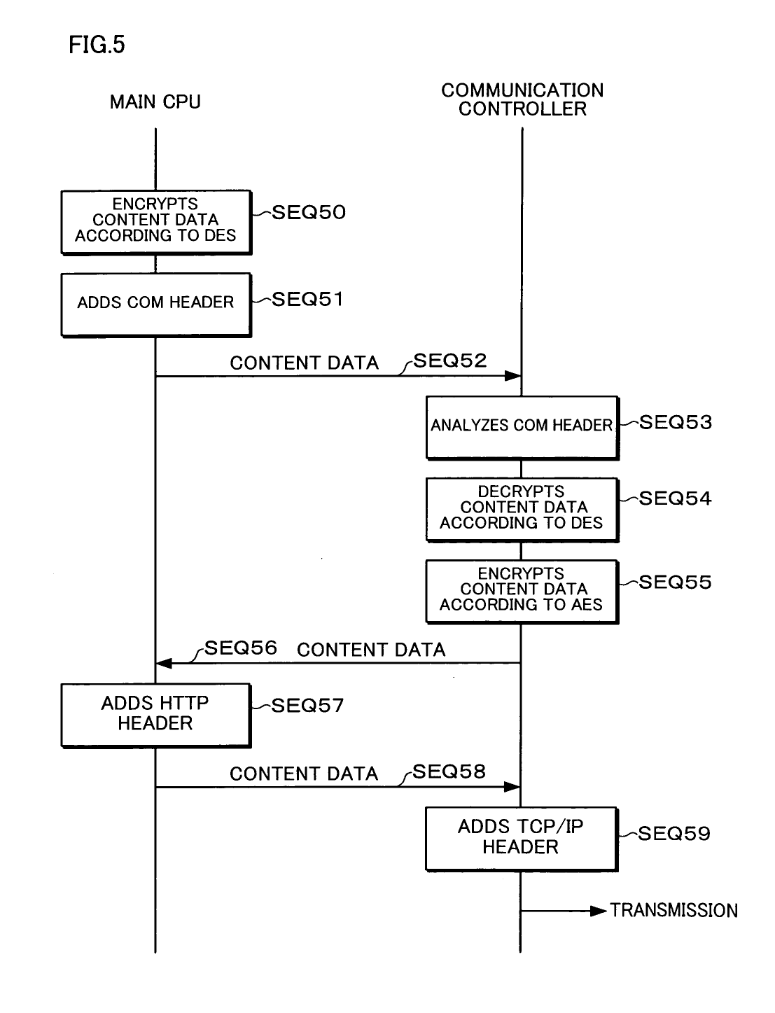

FIG. 5 shows a sequence of an example of content data transmission processing in the communication system shown in FIG. 1.

The main CPU 40 encrypts content data, which the main CPU 40 desires to transmit to the electronic instrument 20, according to the DES algorithm (SEQ50). The main CPU 40 designates the identification information ID corresponding to the transmission destination. The main CPU 40 generates the PCPExtend header and the COM header including control information directing the encryption/decryption device 100 to perform decryption processing according to DES and then encryption processing according to AES, and transmits content data to which the PCPExtend header and the COM header are added to the communication controller 50 (SEQ51 and SEQ52).

The encryption/decryption device 100 of the communication controller 50 analyzes the COM header (SEQ53). The encryption/decryption device 100 decrypts the content data according to the DES algorithm based on the analysis result (SEQ54), and encrypts the decrypted content data according to the AES algorithm (SEQ55). A key corresponding to the identification information ID of the COM header is used in the AES encryption processing. The content data encrypted according to the AES algorithm is transmitted to the main CPU 40 (SEQ56).

The main CPU 40 creates the HTTP header designating the transmission destination corresponding to the identification information ID, and converts the PCPExtend header into the PCP header. The main CPU 40 adds the PCP header and HTTP header to the content data (SEQ57), and transmits the content data to the TCP/IP processing section 60 (SEQ58).

The TCP/IP processing section 60 adds the TCP/IP header specifying the transmission destination corresponding to the electronic instrument 20 (SEQ59), and transmits the content data to the electronic instrument 20.

As described above, content data encrypted according to the AES or DES algorithm is also transferred between the main CPU 40 and the communication controller 50 during the transmission processing. Therefore, content data can be transmitted to the electronic instrument 20 while preventing unauthorized copying of content data.

The encryption/decryption device 100 performs the encryption processing according to the AES algorithm, which imposes a heavy load, in place of the main CPU 40. The main CPU 40 and the encryption/decryption device 100 transmit and receive encrypted content data. However, since it suffices that the main CPU 40 perform encryption processing according to the DES algorithm which imposes a low processing load in comparison with the AES algorithm, the processing performance of the main CPU 40 can be used for other processing, so that throughput can be improved.

The encryption/decryption device 100 of the communication controller 50 encrypts content data according to the AES algorithm and transfers the encrypted content data to the main CPU 40. The main CPU 40 then transfers the encrypted content data to the TCP/IP processing section 60 of the communication controller 50. Therefore, even if a middle layer is provided in the future between the layer to which the HTTP header is added and the layer to which the PCP header is added, it is possible to flexibly deal with such a situation without changing the hardware configuration. This is because the header generation and addition function for such a middle layer can be easily added to the function of the main CPU 40 implemented by software.

The content data transferred between the main CPU 40 and the encryption/decryption device 100 may be divided taking the packet buffering size or the like the into consideration.

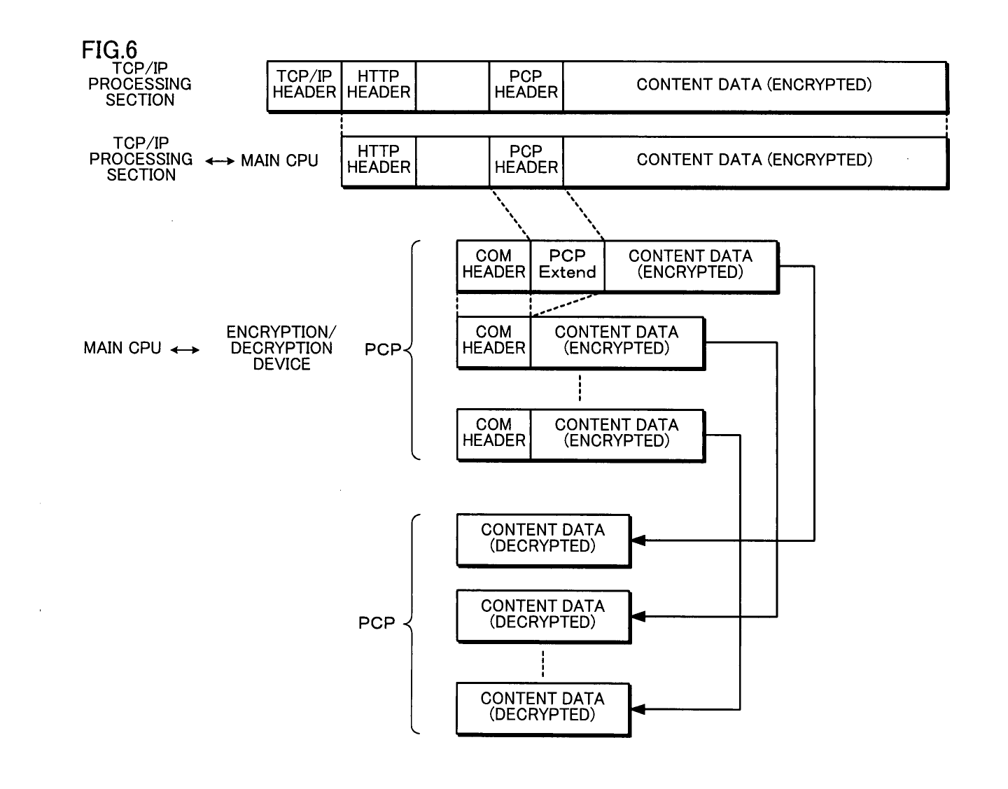

FIG. 6 shows another configuration example of various packets used in the communication system shown in FIG. 1.

As shown in FIG. 6, the COM header is added to each packet. The PCPExtend header is added to only the first divided packet.

The above-mentioned packet division may be easily realized by adding information for determining the presence or absence of the PCPExtend header to the COM header.

2. Encryption/Decryption Device

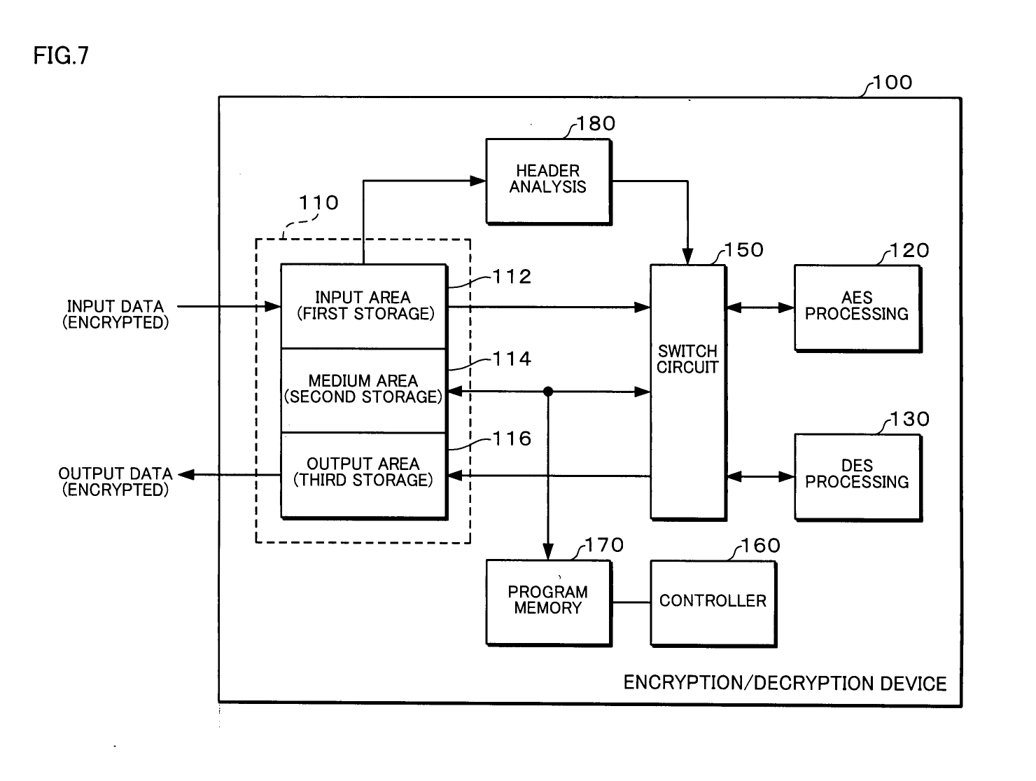

FIG. 7 is a block diagram of a configuration example of the encryption/decryption device 100 shown in FIG. 1.

The encryption/decryption device 100 receives input data after encryption processing according to the AES algorithm (after first encryption processing), and outputs output data after encryption processing according to the DES algorithm (after second encryption processing). Or, the encryption/decryption device 100 receives input data after encryption processing according to the DES algorithm (after second encryption processing), and outputs output data after encryption processing according to the AES algorithm (after first encryption processing).

The encryption/decryption device 100 includes a storage section 110, an AES processing section 120 (first encryption/decryption processing section in a broad sense), and a DES processing section 130 (second encryption/decryption processing section in a broad sense). The storage section 110 stores input data and output data of the encryption/decryption device 100. The function of the storage section 110 is implemented by a memory device such as a static random access memory (SRAM) or a dynamic random access memory (DRAM), a register circuit, a memory device having a First-In First-Out (FIFO) function, or the like.

The AES processing section 120 performs encryption processing according to the AES algorithm (first encryption processing) and decryption processing according to the AES algorithm (first decryption processing).

The DES processing section 130 performs encryption processing according to the DES algorithm (second encryption processing) and decryption processing according to the DES algorithm (second decryption processing).

The encryption/decryption device 100 stores decrypted data, obtained by causing one of the AES processing section 120 and the DES processing section 130 to perform decryption processing according to the AES or DES algorithm for the input data read from the storage section 110, in the storage section 110. The encryption/decryption device 100 stores data, obtained by causing the other of the AES processing section 120 and the DES processing section 130 to perform encryption processing according to the AES or DES algorithm for the decrypted data read from the storage section 110, in the storage section 110 as output data. The storage area of the storage section 110 for the decoded data is configured to be inaccessible from the outside of the encryption/decryption device 100.

The encryption/decryption device 100 may include a switch circuit 150. The switch circuit 150 may switch the path for supplying input data to the AES processing section 120 or the DES processing section 130. The switch circuit 150 may switch the path for supplying data encrypted or decrypted by the AES processing section 120 to the output data storage area or the decrypted data storage area of the storage section 110. The switch circuit 150 may switch the path for supplying data encrypted or decrypted by the DES processing section 130 to the output data storage area or the decrypted data storage area of the storage section 110.

The encryption/decryption device 100 is controlled by a controller 160. The controller 160 may set the key for encryption and decryption processing of the AES processing section 120 and set the key for encryption and decryption processing of the DES processing section 130, for example. The function of the controller 160 is implemented by a CPU. The controller 160 controls the encryption/decryption device 100 according to a program stored in a program memory 170.

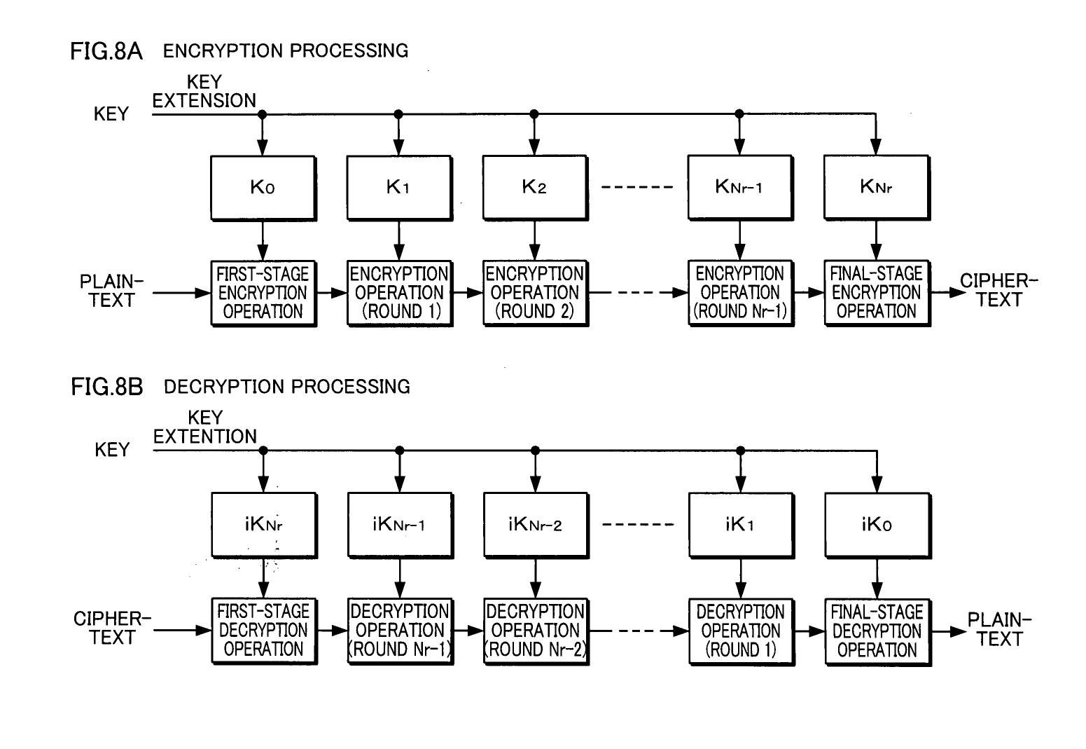

FIGS. 8A and 8B show the flow of processing of the AES processing section 120.

FIG. 8A shows an outline of encryption processing performed by the AES processing section 120. The controller 160 performs extension processing based on the content key Kc acquired as described with reference to FIG. 2 to generate keys K₀, K₁, . . . , K_{Nr} in round units. The AES processing section 120 performs an encryption operation in block units (one block has a length corresponding to 128-bit input data (plaintext)) while changing the key in round units.

In the first-stage encryption operation, an AddRoundkey operation is performed by using the key K₀. A SubBytes operation, a ShiftRows operation, a MixColumns operation, and an AddRoundKey operation are performed from the round 1 to the round (Nr−1) by using the key in each round. In the final-stage encryption operation, the SubBytes operation, the ShiftRows operation, and the AddRoundkey operation are performed.

FIG. 8B shows an outline of decryption processing performed by the AES processing section 120. The controller 160 performs extension processing based on the content key Kc acquired as described with reference to FIG. 2 to generate Keys iK_{Nr}, iK_{Nr-1}, . . . , IK₀ in round units. The AES processing section 120 performs a decryption operation in block units (one block has a length corresponding to 128-bit input data (ciphertext)) while changing the key in round units.

In the first-stage decryption operation, the AddRoundkey operation is performed by using the key iK_{Nr}. An InvShiftrows operation, an InvSubBytes operation, an AddRoundkey operation, and an InvMixColumns operation are performed from the round (Nr−1) to the round 1 by using the key in each round. In the final-stage decryption operation, the InvShifRows operation, the InvSubBytes operation, and the AddRoundkey operation are performed.

The details of each operation in the encryption operation and the decryption operation are described in “Announcing the Advanced Encryption Standard (AES) (Nov. 26, 2001, FIPS PUB 197)”. Therefore, further description is omitted.

As described above, since the AES processing section 120 repeatedly performs the same operations, the processing speed can be increased by implementing the processing of the AES processing section 120 by hardware.

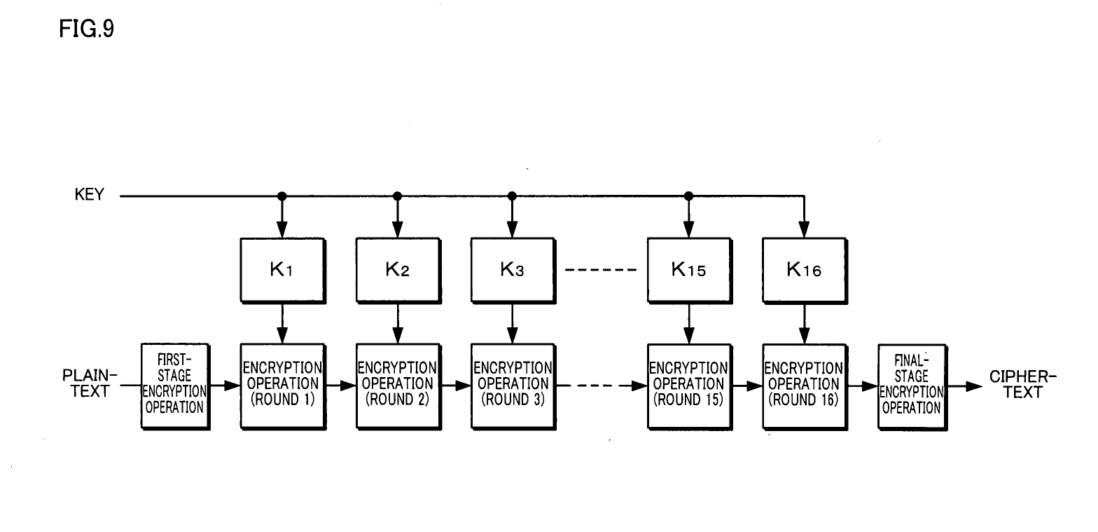

FIG. 9 shows an outline of encryption processing performed by the DES processing section 130.

The encryption/decryption device 100 shares a common private key with the main CPU 40, and holds keys in round units based on the common private key. The DES processing section 130 performs an encryption operation in block units (one block has a length corresponding to 64-bit input data (plaintext)) while changing the key in round units.

In the first-stage encryption operation, an encryption operation such as initial transposition and bit division is performed. Encryption operations such as expansion transposition, exclusive-OR operation using the key in each round, compression substitution conversion, and transposition are performed from the round 1 to the round 16. In the final-stage encryption operation, bit replacement and final transposition are performed.

The decryption processing performed by the DES processing section 130 may be realized by performing each operation shown in FIG. 9 in the reverse order. In this case, the keys are used in the order of K₁₆, K₁₅, . . . , K₁, differing from the encryption processing.

Each operation of the DES processing section 130 is also known in the art. Therefore, description of each operation is omitted.

As described above, since the DES processing section 130 repeatedly performs the same operations, the processing speed can be increased by implementing the processing of the DES processing section 130 by hardware.

As described above, the encryption/decryption device 100 shown in FIG. 7 can perform encryption and decryption processing according to the AES and DES algorithms, and can change the encryption and decryption method for the input data and the output data. This enables data encrypted according to the AES or DES algorithm to be input to the encryption/decryption device 100 and output from the encryption/decryption device 100.

Therefore, even if the storage areas of the storage section 110 for the input data and the output data are configured to be accessible from the outside of the encryption/decryption device 100, unauthorized copying of the input data and the output data is prevented. Moreover, since the decrypted data is stored in the storage area of the storage section 110 inaccessible from the outside of the encryption/decryption device 100, unauthorized copying of the decrypted data is prevented.

In FIG. 7, first to third storage sections 112, 114, and 116 may be independently provided in the storage section 110. The first storage section 112 is a storage section which is accessible from the outside of the encryption/decryption device 100 and stores input data. The second storage section 114 is a storage section which is inaccessible from the outside of the encryption/decryption device 100 and stores decrypted data obtained by decrypting input data according to the AES or DES algorithm. The third storage section 116 is a storage section which is accessible from the outside of the encryption/decryption device 100 and stores output data.

The encryption/decryption device 100 stores data obtained by causing one of the AES processing section 120 and the DES processing section 130 to perform decryption processing in the second storage section 112, and stores data obtained by causing the other of the AES processing section 120 and the DES processing section 130 to perform encryption processing according to the AES or DES algorithm for the decrypted data in the third storage section 116 as output data.

The first to third storage sections 112, 114, and 116 may be provided in divided storage areas in one memory space as an input area (InputArea), a medium area (MediumArea), and an output area (OutputArea), respectively, and each storage area may be variable.

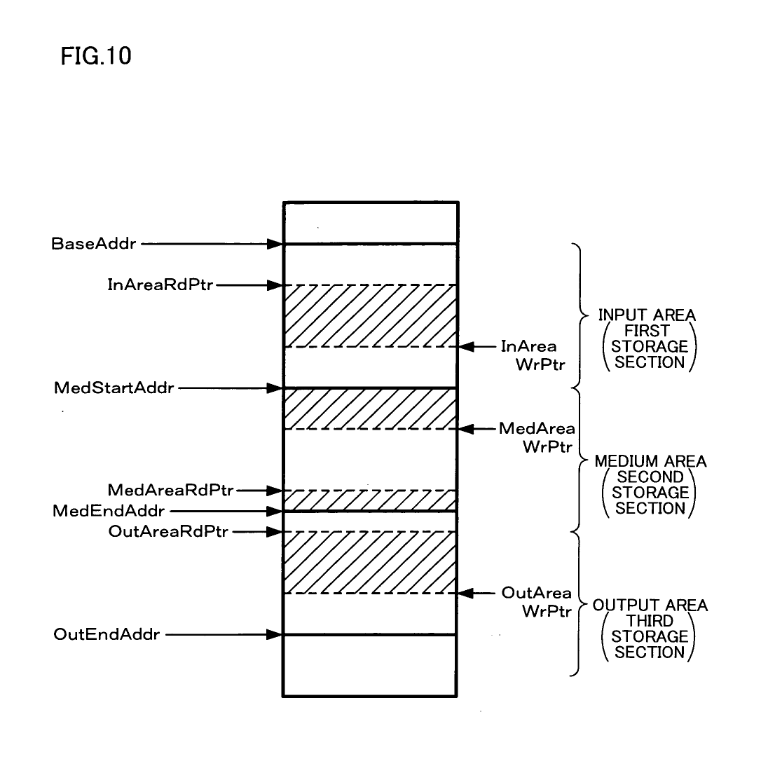

FIG. 10 shows a configuration example of the storage section 110 shown in FIG. 7, in which each storage area is set to be variable.

The input area, the medium area, and the output area of the storage section 110 are specified based on a base address BaseAddr. The encryption/decryption device 100 includes a storage area setting register as a control register (not shown), and the main CPU 40 changes the content set in the storage area setting register.

The storage area setting register may include a medium area start location setting register, a medium area end location setting register, and an output area end location setting register. A medium area start address MedStartAddr is set in the medium area start location setting register. A medium area end address MedEndAddr is set in the medium area end location setting register. An output area end address OutEndAddr is set in the output area end location setting register. As a result, the storage area of the storage section 110 from the address BaseAddr to the address (MedStartAddr−1) is set as the input area. The storage area of the storage section 110 from the address MedStartAddr to the address MedEndAddr is set as the medium area. The storage area of the storage section 110 from the address (MedEndAddr+1) to the address OutEndAddr (or (OutEndAddr−1)) is set as the output area.

It is preferable that the main CPU 40 change the content set in the medium area start location setting register, the medium area end location setting register, and the output area end location setting register based on the content data division unit. If the base address BaseAddr can be changed, the input area, the medium area, and the output area can be set at arbitrary locations of the storage section 110.

In the encryption/decryption device 100, the input area, the medium area, and the output area are accessed as ring buffers. Each area is managed by using a read pointer (InAreaRdPtr, MedAreaRdPtr, OutAreaRdPtr) which designates the data read location and a write pointer (InAreaWrPtr, MedAreaWrPtr, OutAreaWrPtr) which designates the data write location. When the pointer has reached the end address of each area, the pointer is set at the start address of the area when the pointer is updated.

2.1 COM Header

In one embodiment of the invention, content data to which the COM header is added is set in the encryption/decryption device 100 by the main CPU 40. The encryption/decryption device 100 performs encryption and decryption processing corresponding to the content data by analyzing the COM header.

Therefore, the encryption/decryption device 100 shown in FIG. 7 may include a header analysis section 180. The header analysis section 180 detects the COM header added to the content data set in the input area (first storage section), and analyzes the COM header. The encryption/decryption device 100 performs at least one of AES or DES decryption processing corresponding to the COM header for the input data and AES or DES encryption processing corresponding to the COM header for the decrypted data. It becomes unnecessary to provide a control register or the like accessible by the main CPU 40 in order to designate the processing procedure of the encryption/decryption device 100 by providing the header analysis section 180, whereby the control and the configuration of the encryption/decryption device 100 can be simplified.

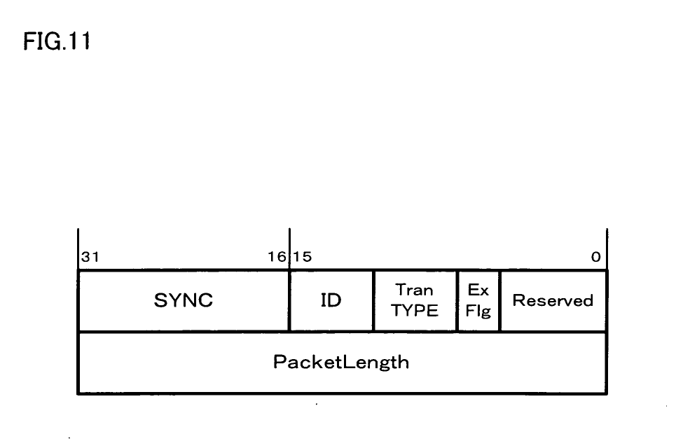

FIG. 11 shows a configuration example of the COM header according to one embodiment of the invention.

The COM header includes a 16-bit length SYNC field, a 4-bit length ID field, a 4-bit length TranTYPE field, a 1-bit length ExFlg field, and a 32-bit length PacketLength field.

A synchronization pattern “A5A5h (h indicates hexadecimal representation)” for confirming that the header is the COM header is set in the SYNC field. A loss of synchronization with the main CPU 40 is detected by performing pattern matching of the synchronization pattern.

Identification information ID for determining the communication partner is set in the ID field. The encryption/decryption device 100 can change the key corresponding to content data in the AES processing section 120 by determining the identification information ID.

Information designating the type of encryption and decryption processing performed by the AES processing section 120 and the DES processing section 130 is set in the TranTYPE field. The operation mode can be changed by setting this information so that the order of encryption and decryption processing of content data can be changed as shown in FIGS. 4 and 5, for example.

Information indicating the addition of the PCPExtend field is set in the ExFlg field. The PCP end location can be specified by referring to this information so that the key update reference timing is obtained.

Information indicating the size of the packet to which the COM header is added is set in the PacketLength field. This information indicates the size of data of the packet excluding the COM header.

The identification information ID set in the ID field is described below.

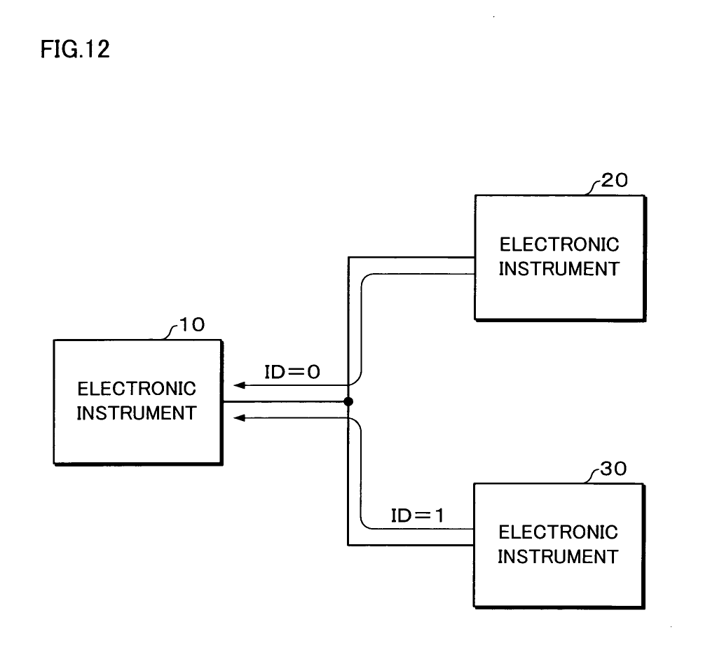

FIG. 12 shows another configuration example of the communication system to which the electronic instrument 10 including the encryption/decryption device according to one embodiment of the invention is applied.

Since the electronic instruments can be connected through an Ethernet cable as described with reference to FIG. 1, the electronic instrument 10 can transmit and receive content data to and from an electronic instrument 30 in addition to the electronic instrument 20.

The electronic instrument 10 must distinguish content data transmitted from the electronic instrument 20 and content data transmitted from the electronic instrument 30. This is because device authentication must be performed between the electronic instruments as specified in the DTCP standard and a key shared between the authenticated electronic instruments differs. Therefore, the electronic instrument 10 must manage the shared key used in the electronic instrument 20 and the shared key used in the electronic instrument 30.

Therefore, when the electronic instrument 10 has specified the sender, the electronic instrument 10 provides the identification information ID corresponding to the sender, and performs decryption processing according to the AES algorithm by using the key corresponding to the identification information ID.

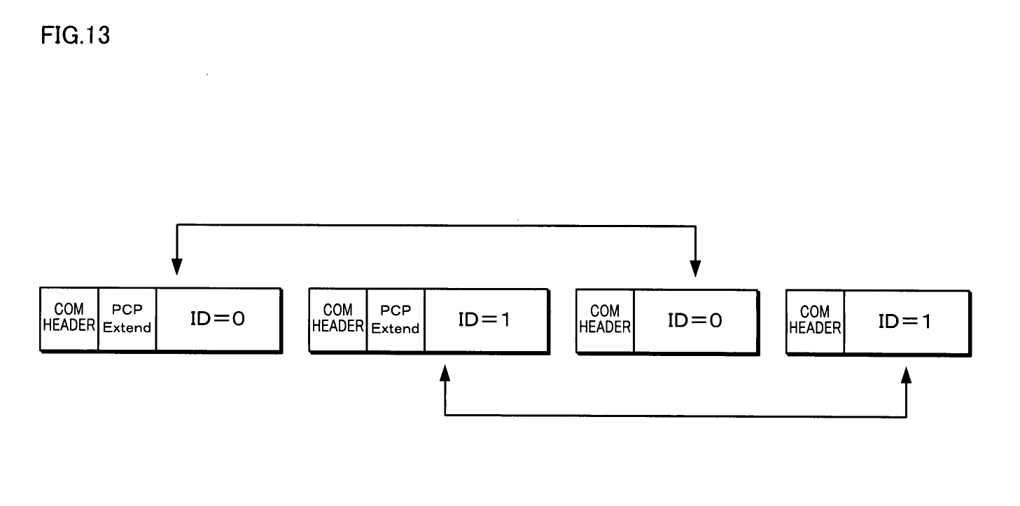

As a result, even when packets containing different types of identification information ID have been transmitted to the electronic instrument 10 as shown in FIG. 13, the encryption/decryption device 100 of the electronic instrument 10 can obtain correctly decrypted content data by changing the key managed in units of identification information ID corresponding to content data.

The information set in the TranTYPE field is described below.

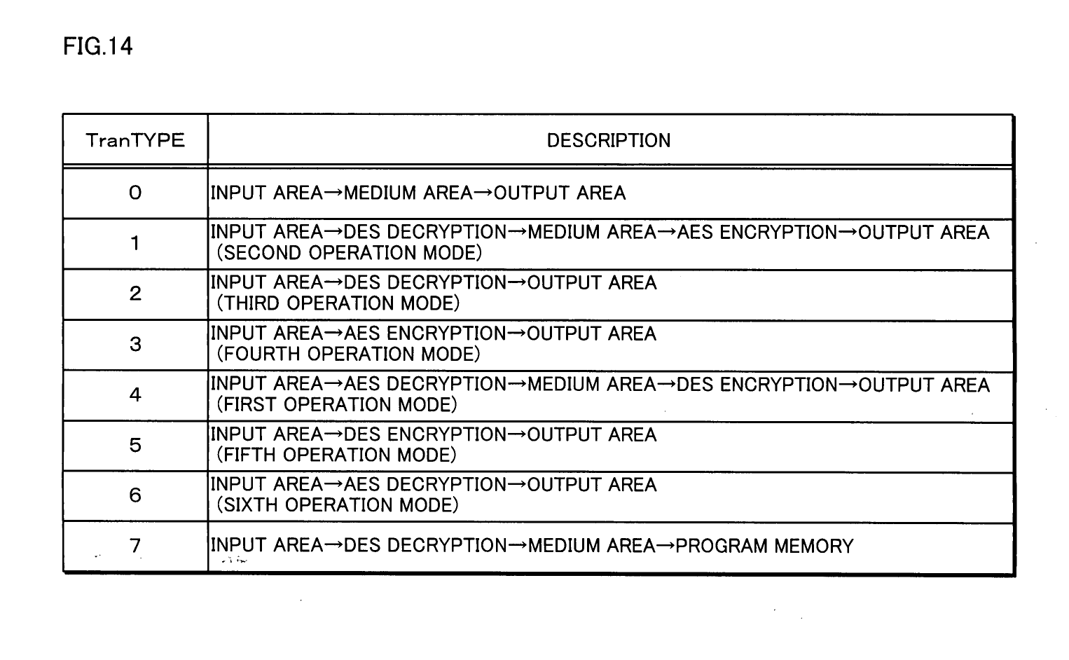

FIG. 14 is a diagram illustrative of the TranTYPE field shown in FIG. 11.

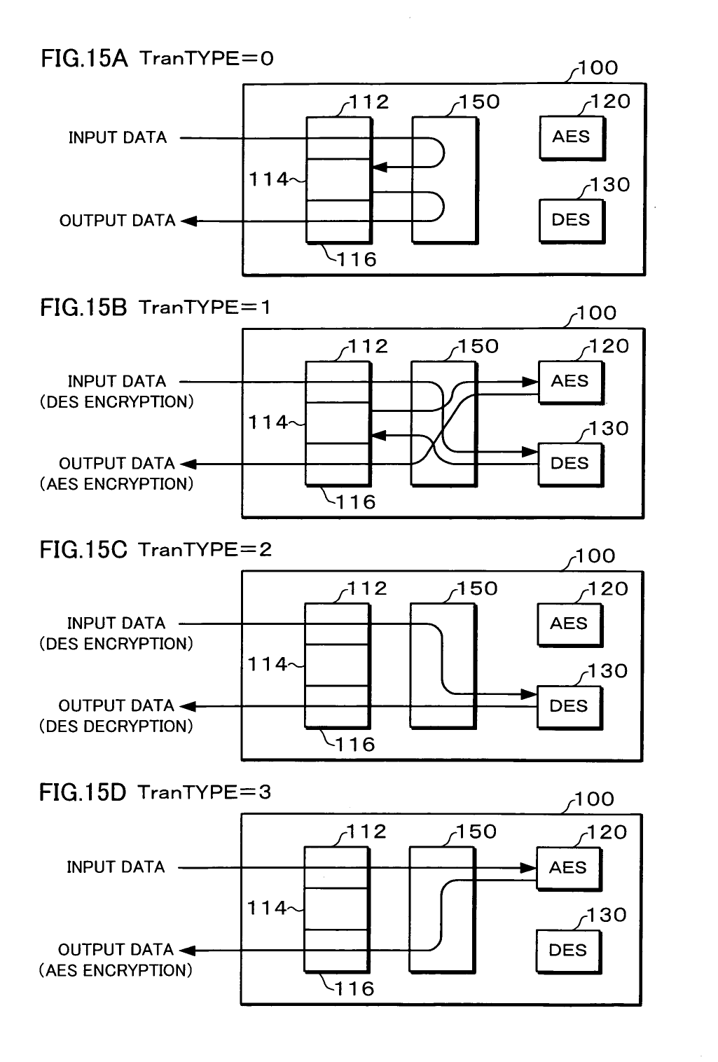

FIGS. 15A to 15D, 16A to 16C, and 17 are diagrams illustrative of the operation mode corresponding to the information set in the TranTYPE field. In FIGS. 15A to 15D, 16A to 16C, and 17, sections the same as the sections shown in FIG. 7 are indicated by the same symbols. Description of these sections is appropriately omitted.

As described above, the encryption/decryption device 100 operates in the operation mode corresponding to the information set in the TranTYPE field.

When “0h” is set in the TranTYPE field, the encryption/decryption device 100 operates in a debug mode. Specifically, as shown in FIG. 15A, content data (input data) written by the main CPU 40 is read from the input area (first storage section) and supplied to the switch circuit 150. The switch circuit 150 directly outputs the content data to the medium area (second storage section) so that the content data is stored in the medium area. After the content data has been read from the medium area and supplied to the switch circuit 150, the switch circuit 150 directly outputs the content data to the output area (third storage section) so that the content data is stored in the output area. This allows the output data read by the main CPU 40 to be the same as the input data.

When “1h” is set in the TranTYPE field, the encryption/decryption device 100 operates in a second operation mode. Specifically, as shown in FIG. 15B, the main CPU 40 stores content data encrypted according to DES in the input area (first storage section) as input data. The content data (input data) is read from the input area (first storage section) and supplied to the switch circuit 150. The switch circuit 150 supplies the content data to the DES processing section 130. The DES processing section 130 decrypts the content data according to the DES algorithm, and supplies the decrypted data to the switch circuit 150 as decrypted data. The switch circuit 150 outputs the decrypted data to the medium area (second storage section) so that the decrypted data is stored in the medium area. After the decrypted data has been read from the medium area and supplied to the switch circuit 150, the switch circuit 150 supplies the decrypted data to the AES processing section 120. The AES processing section 120 encrypts the decrypted data according to the AES algorithm, and supplies the encrypted data to the switch circuit 150 as output data. The switch circuit 150 outputs the output data to the output area (third storage section) so that the output data is stored in the output area. As a result, while the input data stored by the main CPU 40 is data encrypted according to DES, the output data read by the main CPU 40 is data encrypted according to AES. For example, when the communication controller 50 transmits content data, the encryption/decryption device 100 is set in the second operation mode.

When “2h” is set in the TranTYPE field, the encryption/decryption device 100 operates in a third operation mode. Specifically, as shown in FIG. 15C, the main CPU 40 stores content data encrypted according to DES in the input area (first storage section) as input data. The content data (input data) is read from the input area (first storage section) and supplied to the switch circuit 150. The switch circuit 150 supplies the content data to the DES processing section 130. The DES processing section 130 decrypts the content data according to the DES algorithm, and supplies the decrypted content data to the switch circuit 150 as decrypted data. The switch circuit 150 outputs the decrypted data to the output area (third storage section) as output data so that the output data is stored in the output area. As a result, while the input data stored by the main CPU 40 is data encrypted according to DES, the output data read by the main CPU 40 is data decrypted according to DES. For example, when using the encryption/decryption device 100 as a DES decoder, the encryption/decryption device 100 is set in the third operation mode.

When “3h” is set in the TranTYPE field, the encryption/decryption device 100 operates in a fourth operation mode. Specifically, as shown in FIG. 15D, content data (input data) stored by the main CPU 40 is read from the input area (first storage section) and supplied to the switch circuit 150. The switch circuit 150 supplies the content data to the AES processing section 120. The AES processing section 120 encrypts the content data according to the AES algorithm, and supplies the encrypted data to the switch circuit 150. The switch circuit 150 outputs the encrypted data to the output area (third storage section) as output data so that the output data is stored in the output area. As a result, while the input data stored by the main CPU 40 is data before being encrypted according to AES, the output data read by the main CPU 40 is data encrypted according to AES. For example, when using the encryption/decryption device 100 as an AES encoder, the encryption/decryption device 100 is set in the fourth operation mode.

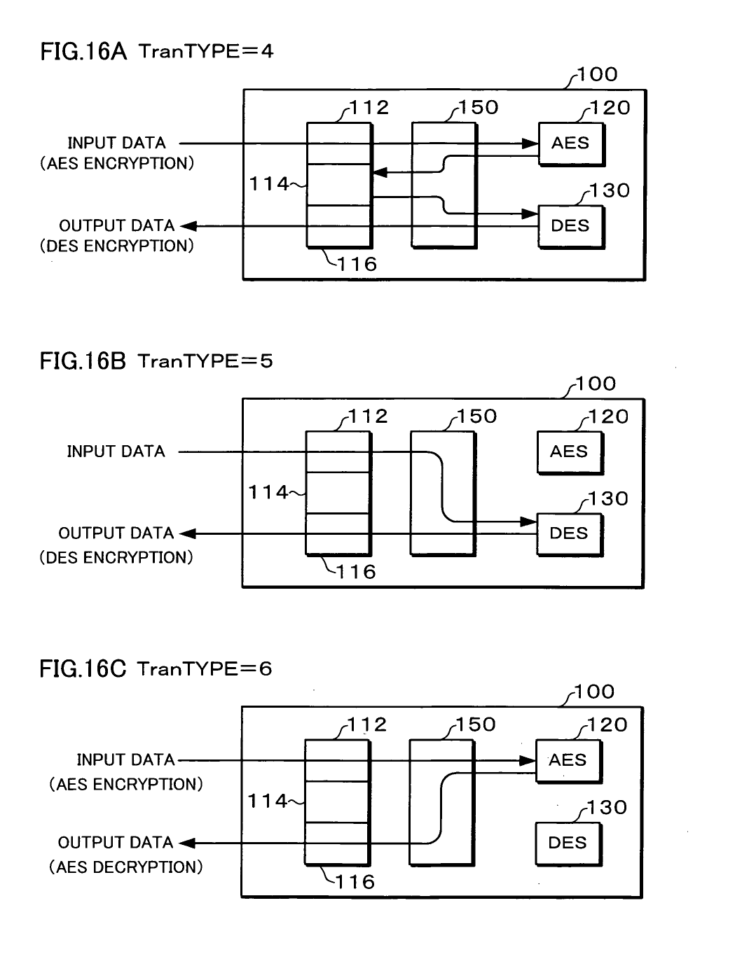

When “4h” is set in the TranTYPE field, the encryption/decryption device 100 operates in a first operation mode. Specifically, as shown in FIG. 16A, the main CPU 40 stores content data encrypted according to AES in the input area (first storage section) as input data. The content data (input data) is read from the input area (first storage section) and supplied to the switch circuit 150. The switch circuit 150 supplies the content data to the AES processing section 120. The AES processing section 120 decrypts the content data according to the AES algorithm, and supplies the decrypted data to the switch circuit 150 as decrypted data. The switch circuit 150 outputs the decrypted data to the medium area (second storage section) so that the decrypted data is stored in the medium area. After the decrypted data has been read from the medium area and supplied to the switch circuit 150, the switch circuit 150 supplies the decrypted data to the DES processing section 130. The DES processing section 130 encrypts the decrypted data according to the DES algorithm, and supplies the encrypted data to the switch circuit 150 as output data. The switch circuit 150 outputs the output data to the output area (third storage section) so that the output data is stored in the output area. As a result, while the input data stored by the main CPU 40 is data encrypted according to AES, the output data read by the main CPU 40 is data encrypted according to DES. For example, when the communication controller 50 receives content data, the encryption/decryption device 100 is set in the first operation mode.

When “5h” is set in the TranTYPE field, the encryption/decryption device 100 operates in a fifth operation mode. Specifically, as shown in FIG. 16B, content data (input data) stored by the main CPU 40 is read from the input area (first storage section) and supplied to the switch circuit 150. The switch circuit 150 supplies the content data to the DES processing section 130. The DES processing section 130 encrypts the content data according to the DES algorithm, and supplies the encrypted data to the switch circuit 150 as output data. The switch circuit 150 outputs the output data to the output area (third storage section) so that the output data is stored in the output area. As a result, while the input data stored by the main CPU 40 is data before being encrypted according to DES, the output data read by the main CPU 40 is data encrypted according to DES. For example, when using the encryption/decryption device 100 as a DES encoder, the encryption/decryption device 100 is set in the fifth operation mode.

When “6h” is set in the TranTYPE field, the encryption/decryption device 100 operates in a sixth operation mode. Specifically, as shown in FIG. 16C, the main CPU 40 stores content data encrypted according to AES in the input area (first storage section) as input data. The content data (input data) is read from the input area (first storage section) and supplied to the switch circuit 150. The switch circuit 150 supplies the content data to the AES processing section 120. The AES processing section 120 decrypts the content data according to the AES algorithm, and supplies the decrypted content data to the switch circuit 150 as decrypted data. The switch circuit 150 outputs the decrypted data to the output area (third storage section) as output data so that the output data is stored in the output area. As a result, while the input data stored by the main CPU 40 is data encrypted according to AES, the output data read by the main CPU 40 is data decrypted according to AES. For example, when using the encryption/decryption device 100 as an AES decoder, the encryption/decryption device 100 is set in the sixth operation mode.

As described above, in the first and second operation modes, the main CPU 40 and the encryption/decryption device 100 can transmit and receive encrypted content data, and the encryption/decryption device 100 can function as an AES or DES encoder or decoder.

In one embodiment of the invention, the encryption/decryption device 100 may operate in a program decryption mode as described below.

Specifically, when “7h” is set in the TranTYPE field, the encryption/decryption device 100 operates in the program decryption mode. In the program decryption mode, when encrypted program data indicating the operation of the controller 160 is supplied from the main CPU 40, the encryption/decryption device 100 decrypts the program data and transfers the decrypted program data to a program memory 170.

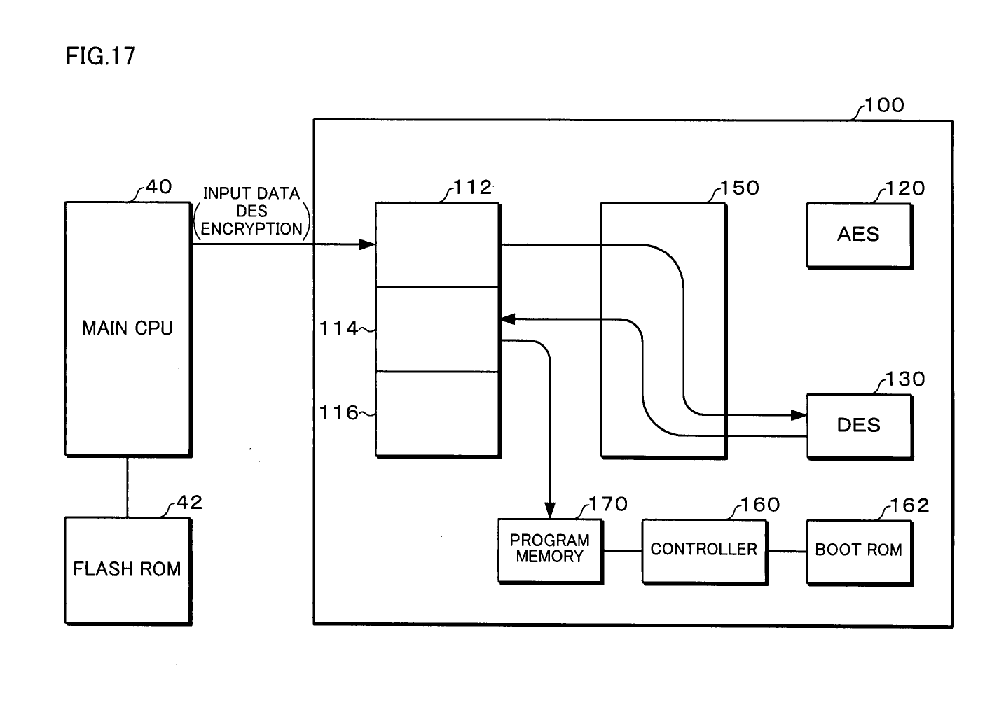

As shown in FIG. 17, it is preferable that a flash read only memory (ROM) 42 which stores program data encrypted according to the DES algorithm be connected with the main CPU 40, and a boot ROM 162 which stores a boot program code be connected with the controller 160. The program data stored in the flash ROM 42 is program data including data for generating an encryption key for performing AES and DES encryption processing and a decryption key for performing AES and DES decryption processing, and indicating the operation of the controller 160. Therefore, when decrypted data has been transferred to the program memory 170 as the program data, the controller 160 can control the operation of the encryption/decryption device 100 based on the program data.

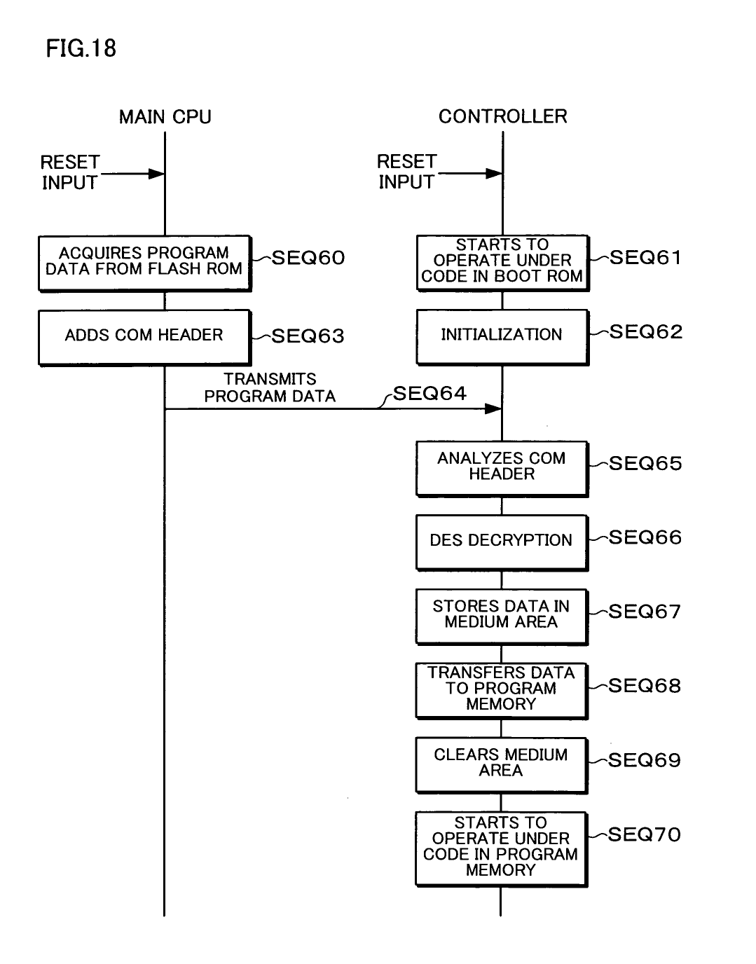

FIG. 18 shows a sequence in the program decryption mode.

When a reset signal is input so that the main CPU 40 is initialized, the main CPU 40 acquires encrypted program data from the flash ROM 42 (SEQ60). The controller 160 is also initialized and starts to operate under the boot program code stored in the boot ROM 162 (SEQ61), and initializes each section of the encryption/decryption device 100 (SEQ62). A DES decryption key is set in advance in the boot program code.

The main CPU 40 adds a COM header in which “7h” is set in the TranTYPE field to the program data (SEQ63), and sets the program data in the input area (SEQ64).

The encryption/decryption device 100 analyzes the COM header (SEQ65). When the encryption/decryption device 100 has determined that “7h” (program decryption mode) is set in the TranTYPE field, the encryption/decryption device 100 reads the encrypted program data from the input area and supplies the program data to the switch circuit 150. The switch circuit 150 supplies the program data to the DES processing section 130. The DES processing section 130 decrypts the program data according to the DES algorithm (SEQ66), and supplies the decrypted program data to the switch circuit 150 as decrypted data. The switch circuit 150 outputs the decrypted data to the medium area so that the decrypted data is stored in the medium area (SEQ67).

The decrypted data stored in the medium area is transferred to the program memory 170 (SEQ68), and the medium area is cleared (SEQ69). Then, the controller 160 starts to operate under the program data stored in the program memory 170 (SEQ70).

Since the program data stored in the program memory 170 includes the procedure and data for generating the AES key as described above, the program data must be encrypted when supplied from the main CPU 40 to the encryption/decryption device 100. Therefore, the second storage section 114 as the medium area can be effectively utilized while maintaining the security of the procedure and data for generating the AES key by using the program decryption mode.

2.2 PCPExtend Header

In one embodiment of the invention, the PCP header specified in “DTCP Volume 1 Supplement E Mapping DTCP to IP (InformationalVersion) (Revision 1.0, Nov. 24, 2003)” is extended to the PCPExtend header.

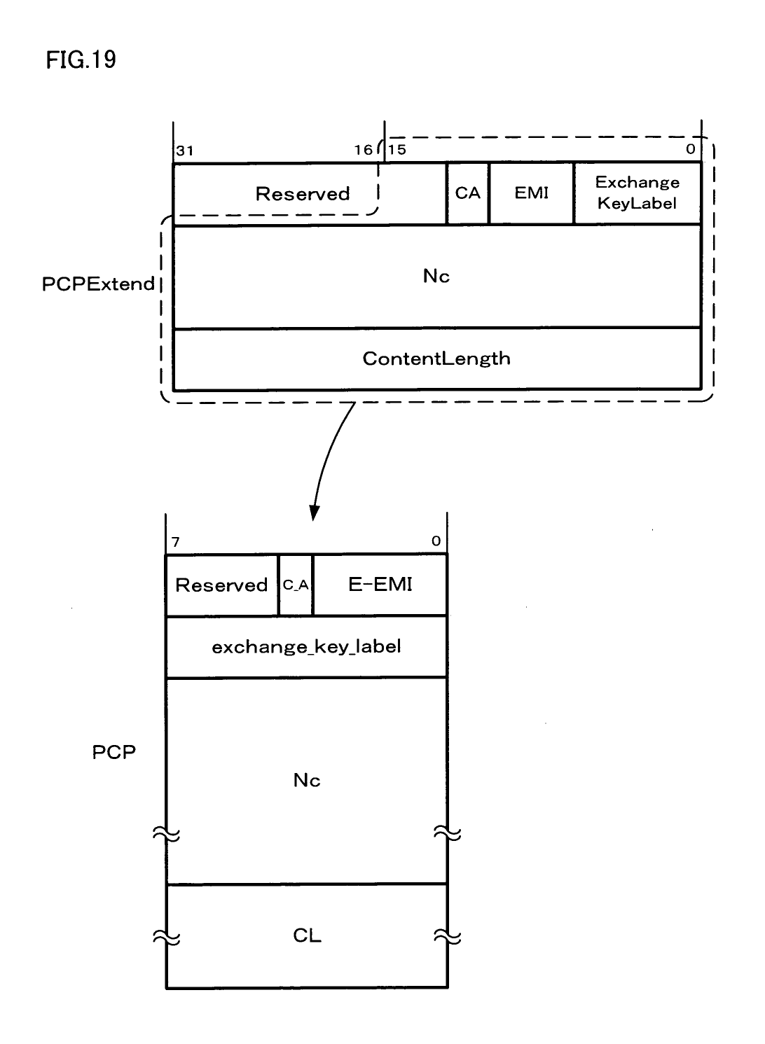

FIG. 19 is a diagram illustrative of the PCPExtend header and the PCP header.

Information set in a C_A field of the PCP header is set in a CA field. Information indicating AES using a 128-bit length block or an optional algorithm is set in the C_A field.

Information set in an E-EMI field of the PCP header is set in an EMI field. Copy control information such as Copy-never, Copy-one-generation, No-more-copies, or Copy-free is set in the E-EMI field.

Information set in an exchange_key_label field of the PCP header is set in an ExchangeKeyLabel field. The exchange key Kx is set in an exchange_key_label field.

Information set in an Nc field of the PCP header is set in an Nc field. The random number used in the expressions (1) and (2) is set in the Nc field.

Information set in a CL field of the PCP header is set in a ContentLength field. The byte length of content data is set in the CL field.

The PCPExtend header differs from the PCP header in that a Reserved field is expanded from three bits to 19 bits. This enables the length of a packet including the COM header and the PCPExtend header to be a multiple of 16 bytes (AES processing unit), so that the circuit configuration can be simplified.

2.3 Hardware Configuration Example

A hardware configuration example of the encryption/decryption device 100 according to one embodiment of the invention is described below.

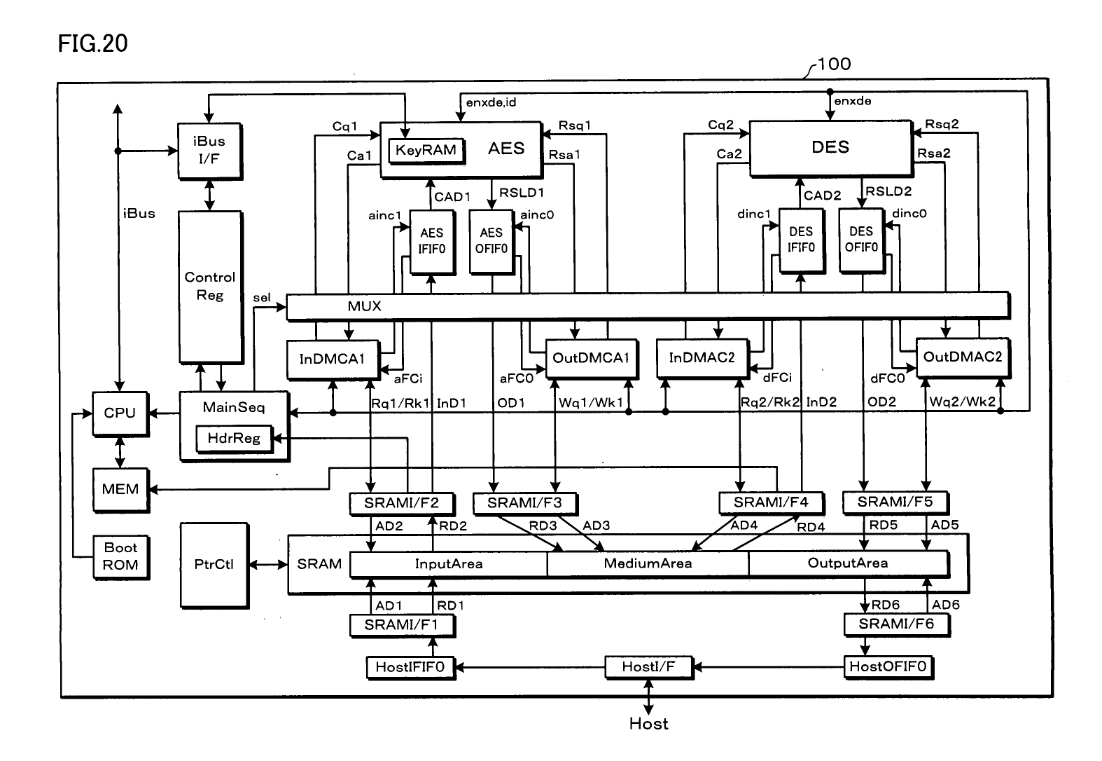

FIG. 20 is a block diagram of a hardware configuration example of the encryption/decryption device 100 shown in FIG. 7.

Host shown in FIG. 20 corresponds to the main CPU 40 shown in FIG. 7. CPU shown in FIG. 20 realizes the function of the controller 160 shown in FIG. 7. MEM shown in FIG. 20 realizes the function of the program memory 170 shown in FIG. 7. BootROM shown in FIG. 20 realizes the function of the boot ROM 162 shown in FIG. 17. SRAM shown in FIG. 20 realizes the function of the storage section 110 shown in FIG. 7. In SRAM shown in FIG. 20, InputArea corresponds to the input area as the first storage section 112. In SRAM shown in FIG. 20, MediumArea corresponds to the medium area as the second storage section 114. In SRAM shown in FIG. 20, OutputArea corresponds to the output area as the third storage section 116. MainSeq shown in FIG. 20 realizes the function of the header analysis section 180 shown in FIG. 7. AES shown in FIG. 20 realizes the function of the AES processing section 120 shown in FIG. 7. DES shown in FIG. 20 realizes the function of the DES processing section 130 shown in FIG. 7. MUX shown in FIG. 20 realizes the function of the switch circuit 150 shown in FIG. 7.

Input data input from Host is input to HostI/F. HostI/F performs input interface processing of input data (input processing between the encryption/decryption device 100 and Host, or signal buffering) and output interface processing of output data (output processing between the encryption/decryption device 100 and Host, or signal buffering). Input data input through HostI/F is buffered by HostIFIFO. Output data buffered by HostOFIFO is output through HostI/F.

SRAMI/F1 reads content data from HostIFIFO. SRAMI/F1 outputs a write address AD1 and write data WD1 to SRAM, and sequentially writes the write data WD1 into the storage area of InputArea of SRAM designated by the address AD1.

PtrCtl updates a write pointer InAreaWrPtr and a read pointer InAreaRdPtr of InputArea of SRAM. PtrCtl also updates a write pointer MedAreaWrPtr and a read pointer MedAreaRdPtr of MedArea of SRAM and a write pointer OutAreaWrPtr and a read pointer OutAreaRdPtr of OutArea of SRAM.

SRAMI/F2 outputs data read from InputArea to MUX or HdrReg of MainSeq. In more detail, SRAMI/F2 outputs a read request Rq1 to InDMAC1. Upon receiving read approval Rk1 from InDMAC1, SRAMI/F2 outputs a read address AD2 to SRAM and reads data from the area designated by the read pointer InAreaRdPtr of InputArea as read data RD2. SRAM/F2 sequentially outputs content data to MUX as data InD1 according to the read approval Rk1 from InDMAC1.

Since the data size of the COM header is known, PtrCtl can detect that writing of the COM header has been completed based on the read pointer InAreaRdPtr. In order to analyze the COM header, when MainSeq has detected completion of writing of the COM header, MainSeq writes the data of the COM header written into InputArea through SRAMI/F2 into HdrReg.

SRAMI/F3 outputs a write address AD3 to MediumArea set in SRAM and writes data from MUX into MediumArea. SRAMI/F3 outputs a write request Wq1 to OutDMAC1. Upon receiving write approval Wk1 from OutDMAC1, SRAMI/F3 outputs a write address AD3 to SRAM and sequentially writes write data WD5 into the area of MediumArea designated by a write pointer MedAreaWrPtr.

Likewise, SRAMI/F4 outputs a read address AD4. SRAMI/F4 reads read data RD4 from MediumArea and sequentially outputs the read data RD4 to MUX. In more detail, SRAMI/F4 outputs a read request Rq2 to InDMAC2. Upon receiving read approval Rk2 from InDMAC2, SRAMI/F4 outputs the read address AD4 to SRAM and reads data from the area of MediumArea designated by a read pointer MedAreaRdPtr as read data RD4. SRAMI/F4 sequentially outputs content data to MUX as data InD2 according to the read approval Rk2 from InDMAC2.

SRAMI/F5 outputs a write address AD5 to OutputArea set in SRAM and writes data from MUX into OutputArea. SRAMI/F5 outputs a write request Wq2 to OutDMAC2. Upon receiving write approval Wk2 from OutDMAC2, SRAMI/F5 outputs the write address AD5 to SRAM and sequentially writes write data WD5 into the area of OutputArea designated by a write pointer OutAreaWrPtr.

SRAMI/F6 outputs a read address AD6. SRAMI/F6 reads read data RD6 from OutputArea and sequentially outputs the read data RD6 to HostOFIFO.

As described above, data transfer from InputArea of SRAM to MUX, data transfer from MUX to MediumArea of SRAM, data transfer from MediumArea of SRAM to MUX, and data transfer from MUX to OutputArea of SRAM are respectively performed by InDMAC1, OutDMAC1, InDMAC2, and OutDMAC2. The transfer control information of InDMAC1, OutDMAC1, InDMAC2, and OutDMAC2 is set in ControlReg.

MainSeq analyzes data set in HdrReg, and sets the transfer control information of InDMAC1, OutDMAC1, InDMAC2, and OutDMAC2 in ControlReg. MainSeq outputs a select signal sel for selecting the transfer path of MUX. The transfer path described with reference to FIGS. 14 to 17 is set based on the select signal sel. MainSeq outputs a decode/encode signal enxde and an identification signal id to AES, and outputs the decode/encode signal enxde to DES. The decode/encode signal enxde is a signal indicating whether to perform decryption processing or encryption processing, and is generated based on the analysis result of the PCPExtend header by CPU. The identification signal id is a signal indicating the identification information ID, and is generated based on the analysis result of the COM header.

InDMAC1 causes AESiFIFO to buffer data InD1 from SRAMI/F2 and supplies data to AES. InDMAC2 causes AESiFIFO to buffer data InD2 from SRAMI/F4 and supplies data to AES. OutDMAC1 supplies data to SRAMI/F3 from AESoFIFO in which data RSLD1 from AES is buffered. OutDMAC2 supplies data to SRAMI/F5 from AESoFIFO in which the data RSLD1 from AES is buffered.

Or, InDMAC1 causes DESiFIFO to buffer the data InD1 from SRAMI/F2 and supplies data to DES. InDMAC2 causes DESiFIFO to buffer the data InD2 from SRAMI/F4 and supplies data to DES. OutDMAC1 supplies data to SRAMI/F3 from DESoFIFO in which data RSLD2 from DES is buffered. OutDMAC2 supplies data to SRAMI/F5 from DESoFIFO in which the data RSLD2 from DES is buffered.

Therefore, a processing request Cq1 is output from MUX to AES corresponding to the transfer path, and processing approval Ca1 is input from AES. A result request Rsq1 is output from MUX to AES corresponding to the transfer path, and result approval Rsa1 is input from AES.

A processing request Cq2 is output from MUX to DES corresponding to the transfer path, and processing approval Ca2 is input from DES. A result request Rsq2 is output from MUX to DES corresponding to the transfer path, and result approval Rsa2 is input from DES.

AES reads data from AESiFIFO according to the processing request Cq1 from InDMAC1 or InDMAC2. AES outputs encrypted or decrypted data to AESoFIFO according to the result request Rsq1 from OutDMAC1 or OutDMAC2. MUX switches the transfer path between one of InDMAC1 and InDMAC2 and AES in response to the processing request Cq1 and the processing approval Ca1. MUX switches the transfer path between one of OutDMAC1 and OutDMAC2 and AES in response to the result request Rsq1 and the result approval Rsa1.

DES reads data from DESiFIFO according to the processing request Cq2 from InDMAC1 or InDMAC2. DES outputs encrypted or decrypted data to DESoFIFO according to the result request Rsq2 from OutDMAC1 or OutDMAC2. MUX switches the transfer path between one of InDMAC1 and InDMAC2 and DES in response to the processing request Cq2 and the processing approval Ca2. MUX switches the transfer path between one of OutDMAC1 and OutDMAC2 and DES in response to the result request Rsq2 and the result approval Rsa2.

As described above, MUX is provided between each area of SRAM and AES and DES, and four DMACs transfer data. The data transfer path is set by MainSeq.

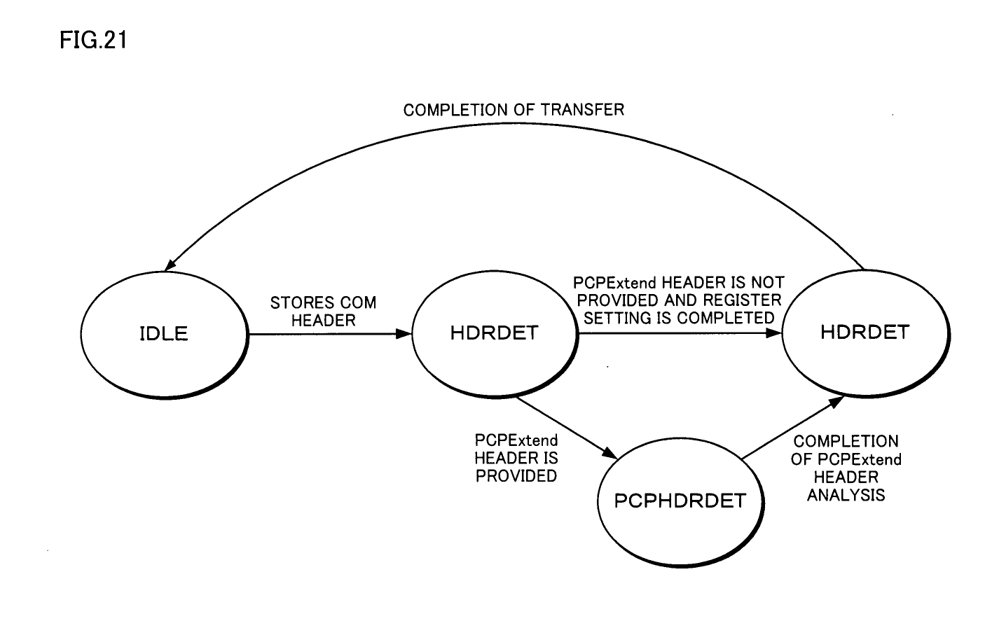

FIG. 21 is a diagram illustrative of the operation of MainSeq shown in FIG. 20.

MainSeq operates according to the state transition diagram shown in FIG. 21. Specifically, MainSeq transitions between each state, and outputs a control signal corresponding to the state after transition to each section of the encryption/decryption device 100.

An IDLE state is a state in which data is input to or output from SRAM and data transfer or the like is not performed. In the IDLE state, when data starts to be set in InputArea and data corresponding to the data size of the COM header is set, MainSeq transitions to an HDRDET state indicating that the COM header has been detected.

In the HDRDET state, the COM header is analyzed. Specifically, based on the information of the COM header shown in FIG. 11, the transfer path is set corresponding to the information set in the TranTYPE field, and the transfer data size of InDMAC1, OutDMAC1, InDMAC2, and OutDMAC2 is set corresponding to the information set in the PacketLength field, for example.

When it is determined in the HDRDET state that the PCPExtend header is added based on the information set in the ExFlg field of the COM header, MainSeq transitions to a PCPHDRDET state. When it is determined in the HDRDET state that the PCPExtend header is not added based on the information set in the ExFlg field of the COM header, MainSeq transitions to a TRANDATA state.

The transition to the PCPHDRDET state is the reference timing of key update performed in PCP units. In FIG. 20, when MainSeq has detected that the PCPExtend header is added based on the information set in the ExFlg field, MainSeq issues an interrupt request to CPU. CPU again generates the key to be updated, and sets the key in KeyRAM of AES through an internal bus iBus and iBusI/F. AES performs encryption processing or decryption processing by using the key set in KeyRAM. After completion of key update, in order to indicate completion of analysis of the PCPExtend header, CPU accesses a start control register included in ControlReg through iBus and iBusI/F. MainSeq transitions to the TRANDATA state after CPU has accessed the start control register.

In the TRANDATA state, AES or DES performs encryption processing or decryption processing through data transfer from SRAM by each DMAC, and the processed data is stored in OutputArea or MediumArea. When the transfer and the encryption processing or decryption processing have been completed, MainSeq transitions to the IDLE state.

3. Modification

In the above-described embodiments, the encryption/decryption device 100 performs encryption and decryption processing according to two algorithms (AES and DES). However, the encryption/decryption device 100 may perform encryption and decryption processing according to three or more algorithms.

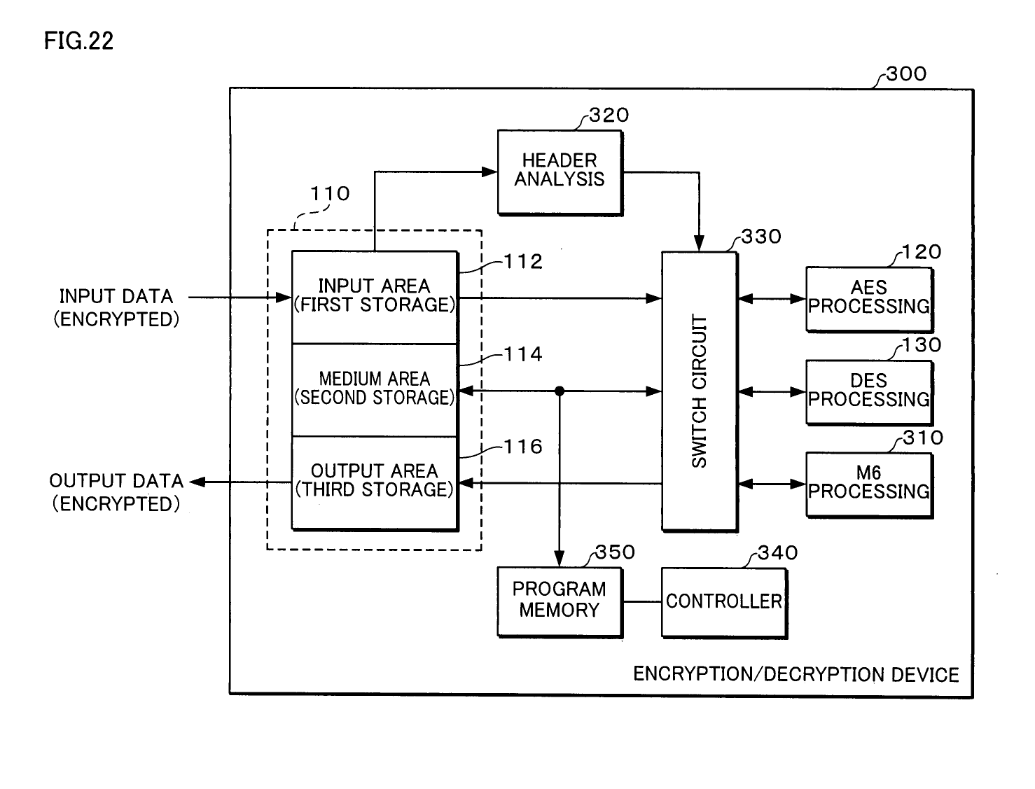

FIG. 22 is a block diagram of a configuration example of an encryption/decryption device in a modification of one embodiment of the invention. In FIG. 22, sections the same as the sections shown in FIG. 7 are indicated by the same symbols. Description of these sections is appropriately omitted.

An encryption/decryption device 300 according to this modification includes an M6 processing section 310 in addition to the AES processing section 120 and the DES processing section 130. The M6 processing section 310 performs encryption and decryption processing according to an encryption algorithm using a common key called “M6”.

A header analysis section 320 has the function of the header analysis section 180 shown in FIG. 7, and sets the transfer path corresponding to TranTYPE of the COM header.

A switch circuit 330 has the function of the switch circuit 150 shown in FIG. 7, and switches the data transfer path based on the analysis result of the header analysis section 320.

In this modification, encryption processing or decryption processing according to one or two algorithms selected from AES, DES, and M6 can be performed in the same manner as in the above-described embodiments. In this case, the function of the processing section for at least one algorithm is disabled.

In this modification, encryption processing or decryption processing of the processing sections for three algorithms may be performed through the second storage section 144 as the medium area.

A controller 340 and a program memory 350 respectively have the function of the controller 160 and the program memory 170 shown in FIG. 7, and generate an encryption key and a decryption key for the M6 processing section 310.

The invention is not limited to the above-described embodiments. Various modifications and variations may be made within the spirit and scope of the invention. For example, the application of the invention is not limited to the above-described AES, DES, and M6. The algorithm of encryption and decryption processing to which the invention is applied is not limited. Moreover, the type of network is not limited to that shown in FIG. 1.

The encryption/decryption device does not necessarily include all the blocks shown in FIGS. 1, 7, and 22. The encryption/decryption device may have a configuration in which some of the blocks are omitted.

Part of requirements of any claim of the invention could be omitted from a dependent claim which depends on that claim. Moreover, part of requirements of any independent claim of the invention could be made to depend on any other independent claim.

Although only some embodiments of the invention have been described in detail above, those skilled in the art will readily appreciate that many modifications are possible in the embodiments without departing from the novel teachings and advantages of this invention. Accordingly, all such modifications are intended to be included within the scope of this invention.

What is claimed is:

1. An encryption/decryption device to which input data after first encryption processing is input and which outputs output data after second encryption processing, or to which input data after the second encryption processing is input and which outputs output data after the first encryption processing, the encryption/decryption device comprising:
a storage section which stores the input data and the output data;
a first encryption/decryption processing section which performs the first encryption processing and first decryption processing; and
a second encryption/decryption processing section which performs the second encryption processing and second decryption processing,
wherein one of the first and second encryption/decryption processing sections performs the first or second decryption processing for the input data read from the storage section, and the decrypted data is stored in the storage section;
wherein the other of the first and second encryption/decryption processing sections performs the first or second encryption processing for the decrypted data read from the storage section after the first or second decryption processing, and the encrypted data is stored in the storage section as the output data; and
wherein a storage area for the decrypted data in the storage section is inaccessible from outside of the encryption/decryption device.

2. An encryption/decryption device to which input data after first encryption processing is input and which outputs output data after second encryption processing, or to which input data after the second encryption processing is input and which outputs output data after the first encryption processing, the encryption/decryption device comprising:
a first storage section which is accessible from outside of the encryption/decryption device and stores the input data;
a first encryption/decryption processing section which performs the first encryption processing and first decryption processing;
a second encryption/decryption processing section which performs the second encryption processing and second decryption processing;
a second storage section which is inaccessible from outside of the encryption/decryption device and stores decrypted data obtained by subjecting the input data to the first or second decryption processing; and
a third storage section which is accessible from outside of the encryption/decryption device and stores the output data,
wherein one of the first and second encryption/decryption processing sections performs the first or second decryption processing for the input data, and the decrypted data is stored in the second storage section; and
wherein the other of the first and second encryption/decryption processing sections performs the first or second encryption processing for the decrypted data after the first or second decryption processing, and the encrypted data is stored in the third storage section as the output data.

3. The encryption/decryption device as defined in claim 2,
wherein the first to third storage sections are respectively provided in divided storage areas in one memory space; and
wherein each of the storage areas is variable.

4. The encryption/decryption device as defined in claim 1, comprising:
a header analysis section which analyzes header information added to the input data,
wherein the encryption/decryption device performs at least one of decryption processing for the input data and encryption processing for the decrypted data, the decryption processing being one of the first and second decryption processing and corresponding to the header information, and the encryption processing being one of the first and second encryption processing and corresponding to the header information.

5. The encryption/decryption device as defined in claim 4,
wherein, when a first operation mode is designated based on the header information, the first encryption/decryption processing section generates the decrypted data by performing the first decryption processing for the input data, and the second encryption/decryption processing section generates the output data by performing the second encryption processing for the decrypted data.

6. The encryption/decryption device as defined in claim 4,
wherein, when a second operation mode is designated based on the header information, the second encryption/decryption processing section generates the decrypted data by performing the second decryption processing for the input data, and the first encryption/decryption processing section generates the output data by performing the first encryption processing for the decrypted data.

7. The encryption/decryption device as defined in claim 4,
wherein, when a third operation mode is designated based on the header information, the second encryption/decryption processing section generates the output data by performing the second decryption processing for the input data.

8. The encryption/decryption device as defined in claim 4,
wherein, when a fourth operation mode is designated based on the header information, the first encryption/decryption processing section generates the output data by performing the first encryption processing for the input data.

9. The encryption/decryption device as defined in claim 4,
wherein, when a fifth operation mode is designated based on the header information, the second encryption/decryption processing section generates the output data by performing the second encryption processing for the input data.

10. The encryption/decryption device as defined in claim 4,
wherein, when a sixth operation mode is designated based on the header information, the first encryption/decryption processing section generates the output data by performing the first decryption processing for the input data.

11. The encryption/decryption device as defined in claim 1, comprising:
a controller which controls operation of the encryption/decryption device; and
a program memory which stores a program for designating operation of the controller, the program including data which is used to generate an encryption key for the first and second encryption processing and a decryption key for the first and second decryption processing,
wherein, after the decrypted data has been transferred to the program memory as program data, the controller controls the operation of the encryption/decryption device based on the program data.

12. The encryption/decryption device as defined in claim 1,
wherein the first encryption/decryption processing section performs encryption and decryption processing compliant with the Advanced Encryption Standard (AES); and
wherein the second encryption/decryption processing section performs encryption and decryption processing compliant with the Data Encryption Standard (DES).

13. A communication controller used to transmit and receive communication data having a layered structure through a network, the communication controller comprising:
a communication processing section which performs transmission processing and reception processing of the communication data; and
the encryption/decryption device as defined in claim 1,
wherein, when the communication data is received, the communication processing section analyzes header information, and the encryption/decryption device performs the first decryption processing and then the second encryption processing for data in a layer higher than a layer of the header information as the input data, and then outputs the data as the output data, the first encryption processing having been performed for the data before reception; and
wherein, when the communication data is to be transmitted, the encryption/decryption device performs the second decryption processing and then the first encryption processing for data to be transmitted as the input data, and then outputs the data as the output data, the communication processing section adds higher-layer header information to the output data, and then the communication controller transmits the resulting output data to the network.

14. An electronic instrument comprising:
the communication controller as defined in claim 13; and
a processing section which performs the second encryption processing and the second decryption processing,
wherein, when the communication data is received, the communication controller supplies data after the second encryption processing to the processing section; and
wherein, when the communication data is to be transmitted, the processing section supplies data after the second encryption processing to the communication controller as the input data.
